(19) United States
(12) Patent Application Publication
(10) Pub. No.: US 2025/0245286 A1
(43) Pub. Date: Jul. 31, 2025

(54) IN-MEMORY MATRIX MULTIPLICATION WITH BINARY COMPLEMENT INPUTS

(71) Applicant: International Business Machines Corporation, Armonk, NY (US)

(72) Inventors: Manuel Le Gallo-Bourdeau, Horgen (CH); Abhairaj Singh, Adliswil (CH); Abu Sebastian, Adliswil (CH); Athanasios Vasilopoulos, Zurich (CH)

(21) Appl. No.: 18/428,850

(22) Filed: Jan. 31, 2024

(51) Int. Cl. G06F 17/16

(52) U.S. Cl. CPC G06F 17/16; G06F 7/5443; G06F 2207/3812; G06F 2207/481

(57) ABSTRACT

A matrix-vector multiplication device includes an input encoder that encodes an input vector into a binary complement format value and a binary true format value; a pulse generator that converts each encoded bit of the binary complement format value and each encoded bit of the binary true format value into a corresponding pulse signal; a crossbar array of weights, wherein each weight is encoded as a differential analog conductance of resistive memory devices, wherein the pulse generator simultaneously applies a pulse signal corresponding to a given encoded bit of the binary complement format value and a pulse signal corresponding to a given encoded bit of the binary true format value to corresponding resistive memory devices; an analog-to-digital converter that digitizes outputs of the crossbar array of weights to generate partial dot-product results; and a digital counter that computes a final dot-product result from the partial dot-product results.

### BACKGROUND

The present invention relates generally to the electrical, electronic and computer arts and, more particularly, to artificial intelligence and machine learning.

Conventional matrix-vector multiply (MVM) hardware architectures are a key compute primitive for a range of applications, such as deep learning inference and training, edge-artificial intelligence (AI), solvers for systems of linear equations, and the like. Conventional analog in-memory computing (AIMC) based hardware accelerators, however, are often incompatible with either digital and analog weight storage and often consume an unsatisfactory amount of area, power, latency, and/or any combination of the foregoing.

### BRIEF SUMMARY

Principles of the invention provide systems and techniques for in-memory matrix multiplication with binary complement inputs.

In one aspect, a matrix-vector multiplication device comprising an input encoder that encodes an input vector into a binary complement format value and a binary true format value; a pulse generator that converts each encoded bit of the binary complement format value and each encoded bit of the binary true format value into a corresponding pulse signal; a crossbar array of weights, wherein each weight is encoded as a differential analog conductance of at least two resistive memory devices, wherein the pulse generator simultaneously applies at least one pulse signal corresponding to a given encoded bit of the binary complement format value to a corresponding resistive memory device of the at least two resistive memory devices and at least one pulse signal corresponding to a given encoded bit of the binary true format value to a corresponding resistive memory device of the at least two resistive memory devices; an analog-to-digital converter that digitizes outputs of the crossbar array of weights to generate partial dot-product results; and a digital COMP counter that computes a final dot-product result from the partial dot-product results.

In one aspect, a matrix-vector multiplication device comprises an input encoder that encodes an input vector into a binary complement format value and a binary true format value; a pulse generator that converts each of one or more sets of bits of the encoded binary complement format value and each of one or more sets of bits of the encoded binary true format value into a corresponding pulse signal; a crossbar array of weights, wherein each weight is encoded as a differential analog conductance of at least two resistive memory devices, wherein the pulse generator simultaneously applies at least one pulse signal corresponding to a given set of the sets of bits of the encoded binary complement format value to a corresponding resistive memory device of the at least two resistive memory devices and at least one pulse signal corresponding to a given set of the sets of bits of the encoded binary true format value to a corresponding resistive memory device of the at least two resistive memory devices; an analog-to-digital converter that digitizes outputs of the crossbar array of weights to generate partial dot-product results; and a digital COMP counter that computes a final dot-product result from the partial dot-product results.

In one aspect, a hardware description language (HDL) design structure is encoded on a machine-readable data storage medium, the HDL design structure comprising elements that when processed in a computer-aided design system generates a machine-executable representation of a semiconductor structure, wherein the HDL design structure comprises an input encoder that encodes an input vector into a binary complement format value and a binary true format value; a pulse generator that converts each encoded bit of the binary complement format value and each encoded bit of the binary true format value into a corresponding pulse signal; a crossbar array of weights, wherein each weight is encoded as a differential analog conductance of at least two resistive memory devices, wherein the pulse generator simultaneously applies at least one pulse signal corresponding to a given encoded bit of the binary complement format value to a corresponding resistive memory device of the at least two resistive memory devices and at least one pulse signal corresponding to a given encoded bit of the binary true format value to a corresponding resistive memory device of the at least two resistive memory devices; an analog-to-digital converter that digitizes outputs of the crossbar array of weights to generate partial dot-product results; and a digital COMP counter that computes a final dot-product result from the partial dot-product results.

In one aspect, a hardware description language (HDL) design structure is encoded on a machine-readable data storage medium, the HDL design structure comprising elements that when processed in a computer-aided design system generates a machine-executable representation of a semiconductor structure, wherein the HDL design structure comprises an input encoder that encodes an input vector into a binary complement format value and a binary true format value; a pulse generator that converts each of one or more sets of bits of the encoded binary complement format value and each of one or more sets of bits of the encoded binary true format value into a corresponding pulse signal; a crossbar array of weights, wherein each weight is encoded as a differential analog conductance of at least two resistive memory devices, wherein the pulse generator simultaneously applies at least one pulse signal corresponding to a given set of the sets of bits of the encoded binary complement format value to a corresponding resistive memory device of the at least two resistive memory devices and at least one pulse signal corresponding to a given set of the sets of bits of the encoded binary true format value to a corresponding resistive memory device of the at least two resistive memory devices; an analog-to-digital converter that digitizes outputs of the crossbar array of weights to generate partial dot-product results; and a digital COMP counter that computes a final dot-product result from the partial dot-product results.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
a single-phase matrix-vector multiplication (MVM) technique applicable to both analog and digital weights using two's complement and ones' complement plus one formats in either a bit-serial or bit-parallel mode;
an MVM embodiment (see FIG. 14B) that utilizes true and two's complement data input and obviates the need for a duplication of weights, obviates the need for a differential analog-to-digital converter (ADC), obviates the need for both P and N counters in the single-ended ADC (SE-ADCs), drastically reduces the probability of having I_{colm} (the current flowing in the BL, where the BL is the common access line for all rows in a column; in AIMC, this is the analog compute output) of approximately zero and eliminates the notion of having positive or negative outputs, resulting in an expected circuit area and power improvement;
an MVM embodiment that eliminates the need to adjust the dynamic range of the ADC since the maximum current remains the same due to an ˜50% data input (IN) bit-sparsity, resulting in an improved signal-to-noise ratio (SNR), making the calculation more accurate and reducing the complexity of the ADC;
an MVM embodiment (see FIG. 15) that utilizes true and complementary weights with true and ones' complement+1 data input (INs) and obviates the need for an operational transconductance amplifier (OTA) (in voltage- or time-based sensing techniques, obviates the need for sign-detection, obviates the need for a differential ADC, obviates both P and N counters in SE-ADCs, drastically reduces the probability of having I_{colm}˜0 and eliminates the notion of having positive or negative outputs, resulting in an expected circuit area and power improvement;
an MVM embodiment (see FIG. 15) that eliminates the need to adjust the dynamic range of the ADC since the maximum current remains constant due to an ˜50% data input (IN) bit-sparsity of true and two's complement data inputs (INs);
a reduction in the cumulative A/D conversion energy and latency for the entire MVM operation; and
a merge ADC embodiment that merges certain post-processing tasks and ADC counter tasks and that replaces two counters, two multiply units and a register with a single COMPP counter with multiply capability suitable for any MVM-type operation.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates a conventional matrix-vector multiply (MVM) architecture that exploits Kirchhoff's circuits laws;

FIG. 2 illustrates the input mapping for a conventional digital-to-analog converter and crossbar array;

FIG. 3 illustrates the bit-parallel and bit-serial configurations for differential IN mode;

FIG. 4 illustrates the single-ended IN mode in two phases;

FIG. 5 illustrates conventional weight mapping electronic circuitry for a crossbar array;

FIG. 6 illustrates conventional single-ended ADC (SE-ADC) and differential ADC (AADC) circuits;

FIG. 7 illustrates a conventional architecture for generating an output using a single-ended ADC configuration;

FIG. 8A illustrates the post-processing of the output of the SE-ADC;

FIG. 8B is a block diagram of an example ADC compute unit for performing post-processing of the output of the increment counter (INC);

FIG. 9A is a table of remarks regarding speed, area and energy-efficiency for both the bit-parallel and bit-serial configurations;

FIG. 9B is a table of remarks regarding speed, area and energy-efficiency for the SE-ADC and AADC;

FIG. 10 is a circuit diagram of a voltage-based ADC (voltage sensing configuration);

FIG. 11 illustrates the post-processing of the output of the ADCs;

FIG. 12 is a block diagram of an example system for performing in-memory matrix multiplication, in accordance with example embodiments;

FIG. 13 is a flowchart for determining example viable configurations of the in-memory matrix multiplication architecture of FIG. 12, in accordance with an example embodiment;

FIG. 14A illustrates conventional single-ended ADC (SE-ADC) and differential ADC (AADC) circuits;

FIG. 14B illustrates an example single-ended ADC configuration for performing MVM operations, in accordance with an example embodiment;

FIG. 15 illustrates another example single-ended ADC configuration for performing MVM operations, in accordance with an example embodiment;

FIG. 16 illustrates three cycles of a right-shift operation that enables a reduction in the size of the counter, in accordance with example embodiments;

FIG. 17 is an example architecture for reducing the size of the counter, in accordance with an example embodiment;

FIG. 18A is a block diagram of a conventional ADC compute configuration, in accordance with example embodiments;

FIG. 18B is a block diagram of an example ADC compute configuration, in accordance with example embodiments;

FIG. 19A illustrates two examples of a split pulse width modulation (PWM) approach, in accordance with example embodiments;

FIG. 19B describes an algorithm to accommodate IN significance in the pre- and post-processing of the ADC results, in accordance with example embodiments;

FIG. 20A illustrates the results of simulations using a conventional programming and numeric computing platform, in accordance with example embodiments;

FIG. 20B illustrates results of simulations using the conventional programming and numeric computing platform including experimentally-verified phase change memory (PCM) programming errors, in accordance with example embodiments;

FIG. 20C illustrates results of simulations using a PCM-based in-memory computing (IMC) core, in accordance with example embodiments;

FIG. 21 depicts a computing environment according to an embodiment of the present invention (e.g., for implementing a design process such as that of FIG. 22); and

FIG. 22 is a flow diagram of a design process used in semiconductor design, manufacture, and/or test.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

### Analog Matrix-Vector Multiply (MVM)

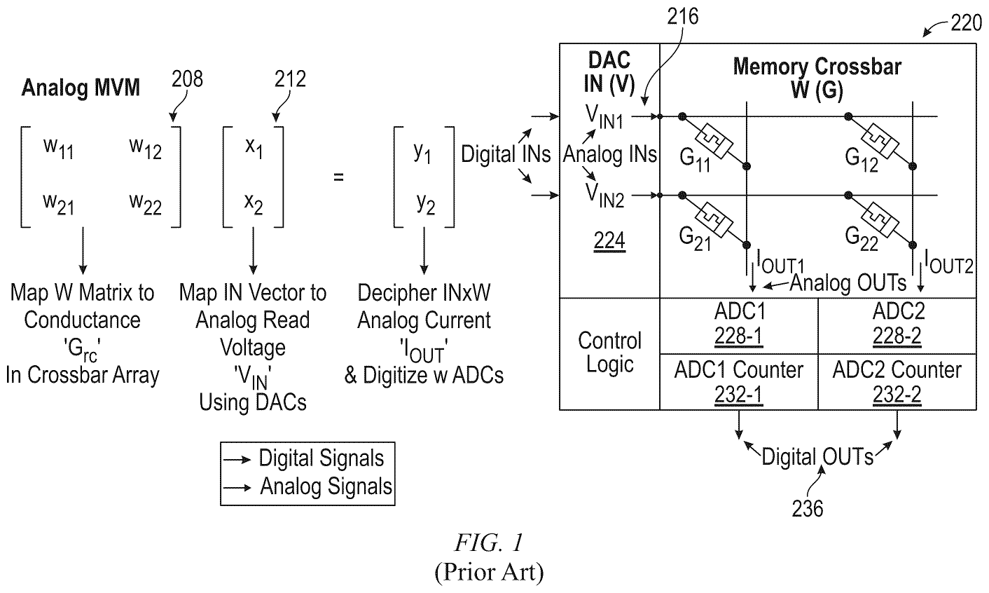

FIG. 1 illustrates a conventional matrix-vector multiply (MVM) architecture that exploits Kirchhoff's circuits laws. The in-place matrix-vector multiply (MVM) operations operate with O(1) time complexity. The weight matrix W 208 is mapped to the conductances in the crossbar array 220 and the data input (IN) vector 212 is mapped to an analog read voltage V_{IN} 216 using digital-to-analog converters 224. The product of the IN vector 212 and the weight matrix 208 is deciphered and the analog output of the crossbar array 220 is digitized with analog-to-digital converters 228-1, 228-2. ADC counters 232-1, 232-2 compute the final digital output 236. The conventional matrix-vector multiply (MVM) architecture of FIG. 1 is a key compute primitive for a range of applications, such as deep learning inference and training, edge-artificial intelligence (AI), solvers for systems of linear equations, and the like.

### Pertinent Challenges 1: Computational Accuracy

Achieving sufficient computational accuracy is a pertinent challenge for AIMC using variation-prone analog storage or with overlapping digital levels for, for example, pulse code modulation (PCM). Drop-in computational accuracy is mostly determined by weight programming errors and circuit non-idealities, such as digital-to-analog and analog-to-digital conversion errors, wire resistance-capacitance mismatch, process/voltage/temperature (PVT) variations, and the like. Pertinent aspects here are the challenges related to computing accuracy due to weight programming errors and circuit non-idealities. These lead to a distribution in the outcome of AIMC-based computing which translates to inaccuracies. MVM measured results and probability density function (PDF) graphs show this distribution in terms of error percentage from the ideal MVM value. Note that the PDF is a statistical expression that defines the probability that some outcome will occur. In this function, the probability is the percentage of a dataset's distribution that falls between two criteria.

### Pertinent Challenges 2: Computational Efficiency

The power consumption of fully parallel in memory computing (IMC) is a key aspect of computational efficiency, including the contribution of ADCs and digital-to-analog converters (DACs) in the overall power consumption of the AIMC. In one scenario, resistive random-access memory (ReRAM) consumes 15% of the power, 2-bit digital-to-analog converters (DAC/2-bit) consume approximately 25% and 8-bit analog-to-digital converters (ADC/8-bit) consume approximately 60%. Computational efficiency is mainly dominated by digital-to-analog and analog-to digital converters where high accuracy is achieved at the expense of high latency and high energy consumption. Example embodiments improve both the DAC and ADC aspects to improve the efficiency of AIMC,

### Conventional Input Mapping

FIG. 2 illustrates the input mapping for a conventional digital-to-analog converter 224 and crossbar array 220 (seen in FIG. 1). The input (IN) activation 404 can be represented in two ways (as illustrated in the example of FIG. 2, the amplitude V_{IN*} is either VDD or GND). In a bit-parallel configuration, the pulse width represents the value of the input. In a bit-serial configuration, the crossbar array 220 is activated for each bit that is one and not activated for each bit that is zero. For a differential configuration, the process is performed in two phases. For example, positive values may be processed during phase #1 and negative values may be processed during phase #2.

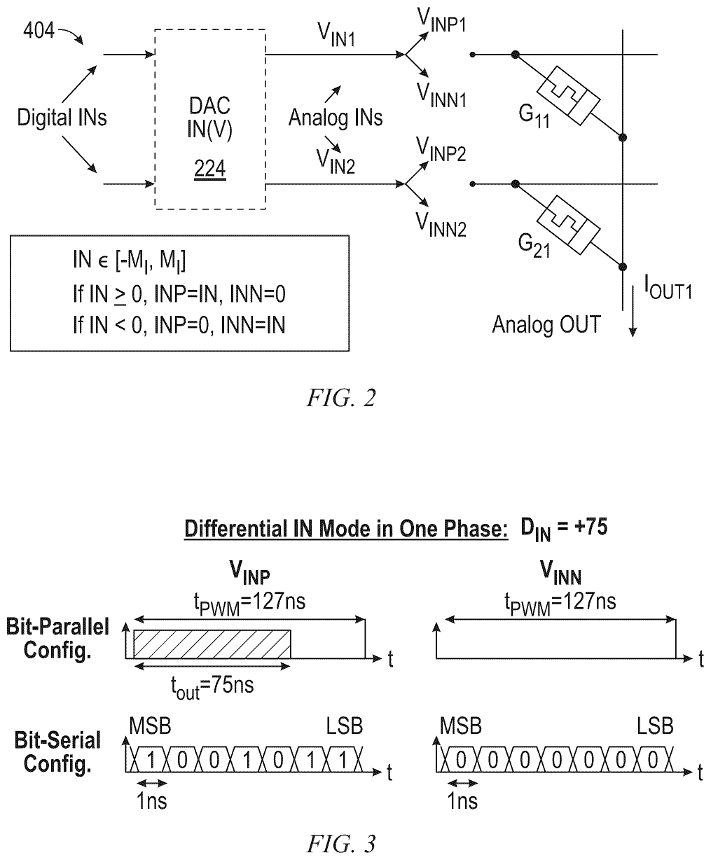

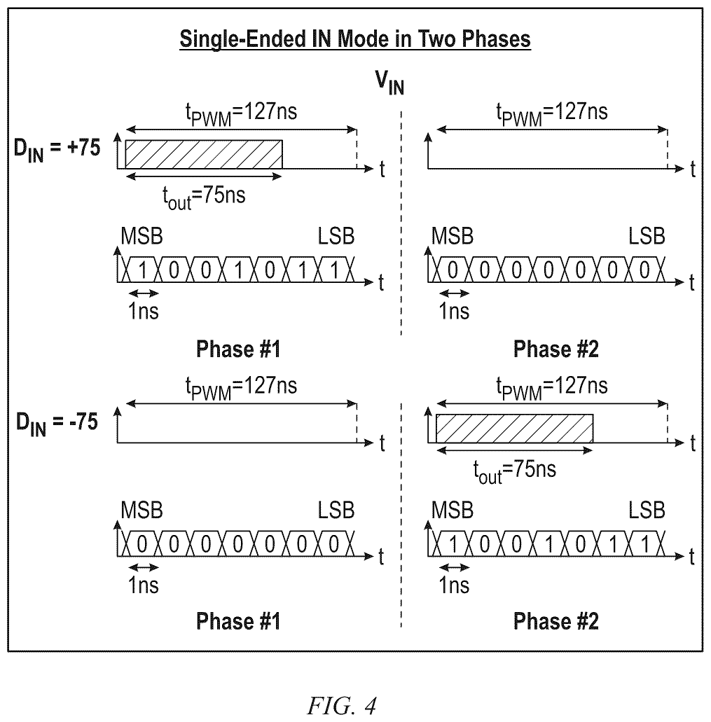

FIG. 3 illustrates the bit-parallel and bit-serial configurations for differential IN mode. FIG. 4 illustrates the single-ended IN mode in two phases. In the bit-parallel configuration the memory cells are enabled for a duration proportional to the magnitude of IN 404 using pulse-width modulation (PWM) and the unit delay is dependent on the IN bits. (In the differential configuration, V_{INP} and V_{INN} are both pulse width modulated.)

In the bit-serial configuration (where a multi-cycle read is performed, each with a unit delay duration), the maximum number of pulse cycles is determined by the number of IN bits. For example, inputting eight bits requires eight pulse cycles. Each cycle has a V_{IN} value of VDD and ground (GND) for a data bit value of 1 and 0, respectively.

The mechanism for taking care of the sign of IN 404 is based on the mode. In a single-ended IN mode, only V_{IN} is available, and the input activation is in two phases, i.e., a positive phase and a negative phase. In the differential IN mode, the positive input (V_{INP}) or the negative input (V_{INN}) is activated depending on the polarity.

### Conventional Weight Mapping

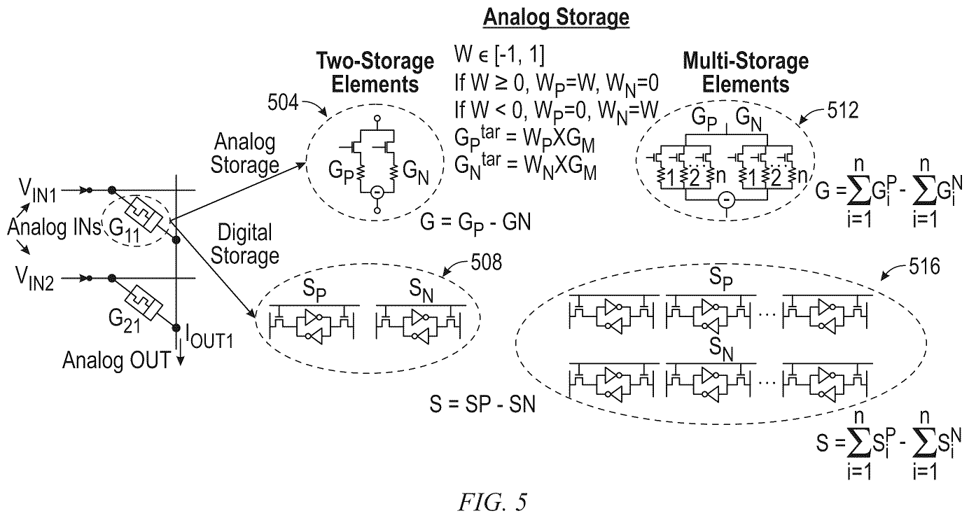

FIG. 5 illustrates conventional weight mapping electronic circuitry 504, 508, 512, 516 for a crossbar array 220. The synaptic weight is represented by a unit cell 504, 508 organized in a differential manner. In an analog configuration (unit cell 504), there are two memristive device conductances (G_{P} and G_{N}). In a digital configuration (unit cell 508), there are two static random-access memory (SRAM) bitcell states (S_{P} and S_{N}).

In the analog configuration (unit cell 504), the mapping is done with the conductance of one device, either the positive weight (G_{P}) or the negative weight (G_{N}), and the other device is reset to 0 conductance (depending on the polarity of the target weight). The target weight is scaled with an arbitrarily-chosen G_{M} factor that represents the maximum conductance value that a device is programmed to. The analog output is accumulated from the positive side and from the negative side.

In the digital configuration (unit cell 508), state 1 is stored in the SRAM cell, either the positive (S_{P}) or negative (S_{N}) SRAM cell, and the other state is 0 (depending on the polarity of the target weight).

As illustrated on the right-side of FIG. 5, multi-storage elements can also be used. For example, in an analog configuration (unit cell 512), if the precision of the weight when using one device is not sufficient for the desired accuracy of a particular application, such as a neural networking inferencing application, the conductance range and/or resolution needs to be increased for given weight elements. In this case, multi-storage elements can be used. In a digital configuration (unit cell 516), multi-bit storage is required to represent a multi-bit weight.

### Conventional Weight Mapping and ADC Compute

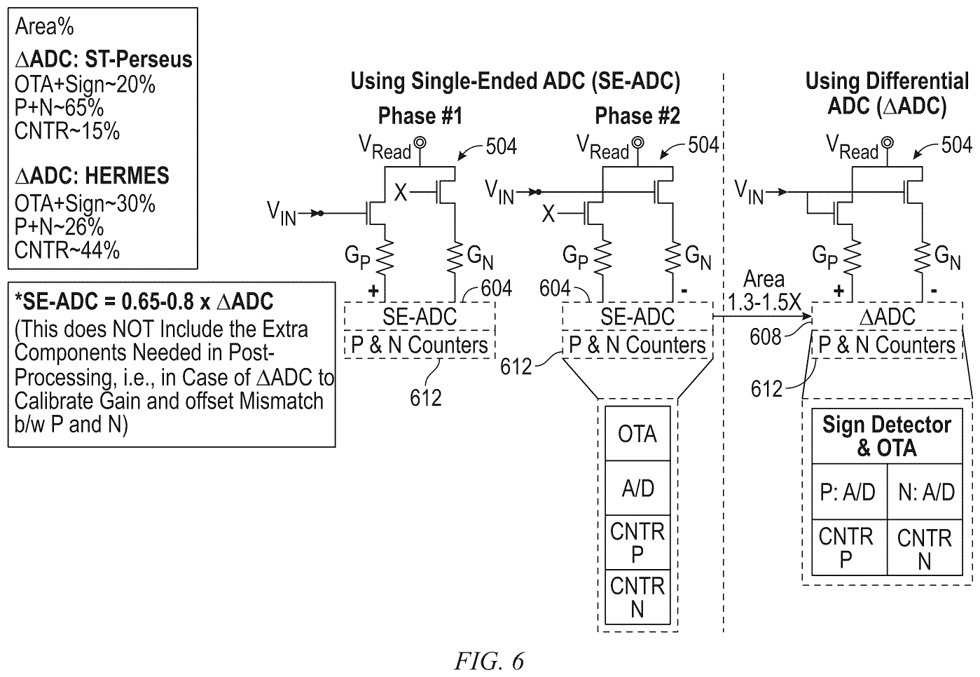

FIG. 6 illustrates conventional single-ended ADC (SE-ADC) and differential ADC (ΔADC) circuits. If a ΔADC is utilized, the analog inputs typically need to be subtracted as part of the MVM operation. For single analog inputs or for inputs having the same sign, an SE-ADC 604 can be used.

Referring to the left-side of FIG. 6, the positive part of the input is input during phase #1 to generate the positive output via the positive counter of the P & N counters 612, the negative part of the input is input during phase #2 to generate the negative output via the negative counter of the P & N counters 612 and the two outputs are combined after the two phases are performed. Alternatively, as illustrated on the right-hand side of FIG. 6, a differential analog-to-digital converter 608 can be used to digitize a differential output when the positive side and the negative side are applied during the same single phase. Generally, a differential analog-to digital converter 608 provides less latency than the single-ended ADC 604, but is larger, more complicated, and consumes more area and energy than the single-ended ADC 604.

In terms of area, the SE-ADC 604 is typically smaller than the ΔADC 608 by a factor of about two, as components like a sign detector and dedicated conversion stages work depending on whether net results are positive/negative. In terms of latency, ΔADC 608 needs a single MVM phase to determine the net result, whereas SE-ADC 604 needs two phases. In terms of energy per complete MVM, ΔADC 608 is typically better as the Energy(ΔADC)<2*Energy(ADC), since the ΔADC 608 runs only once per operation. Note that Energy(ΔADC)>Energy(ADC). In addition, other components, such as digital-to-analog converters (DACs) and the crossbar processing, also run twice during each MVM operation when using SE-ADCs.

### Conventional Post-Processing of A/D Bits

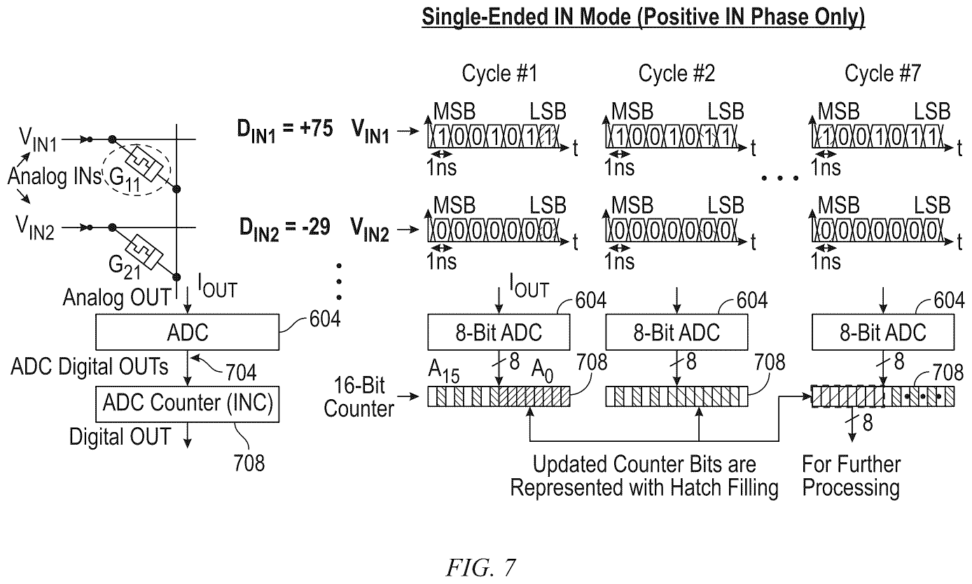

FIG. 7 illustrates a conventional architecture for generating an output using a single-ended ADC configuration. In bit-serial mode, 1-bit is provided to Vm during each cycle. For example, bits may be provided, one by one, starting with the least significant bit and ending with the most significant bit (MSB). In each of these cycles, an 8-bit ADC output 704 is produced by the SE-ADC 604 and the ADC output 704 is aggregated in an increment counter (INC) 708. In the example embodiment of FIG. 7, the size of the increment counter is 16-bits, identified as bits A₁₅-A₀.

The significance of the IN bits is typically taken care of by shifting the specific 8-bits that are to be incremented. Depending on the significance of the partial output digital bits, the partial output digital bits are to be shifted before aggregating with the existing partial sum in the counter. The amount to increment is selected based on the significance of a particular digital partial-output. With each step, from the least significant bit to the most significant bit, bits selected for incrementing are shifted by one (implying scaling by a factor of two). For instance, for the least significant bit (LSB) of IN: counter bits A₇-A₀ are incremented; for (LSB+1) of IN: counter bits A₈-A₁ are incremented; and for the most significant bit (MSB) of IN: counter bits A₁₄-A₇ are incremented. A₁₅ is generally maintained for a potential overflow. The number of bits required for further processing is generally much less than 16; typically, in the range of 8-bits for artificial intelligence (AI) applications. In this case, the most significant 8-bits of the counter (A₁₅-A₈) are propagated for further processing and the least significant bits (A₇-A₀) are discarded.

### Conventional Post-Processing of A/D Bits (ADC Compute)

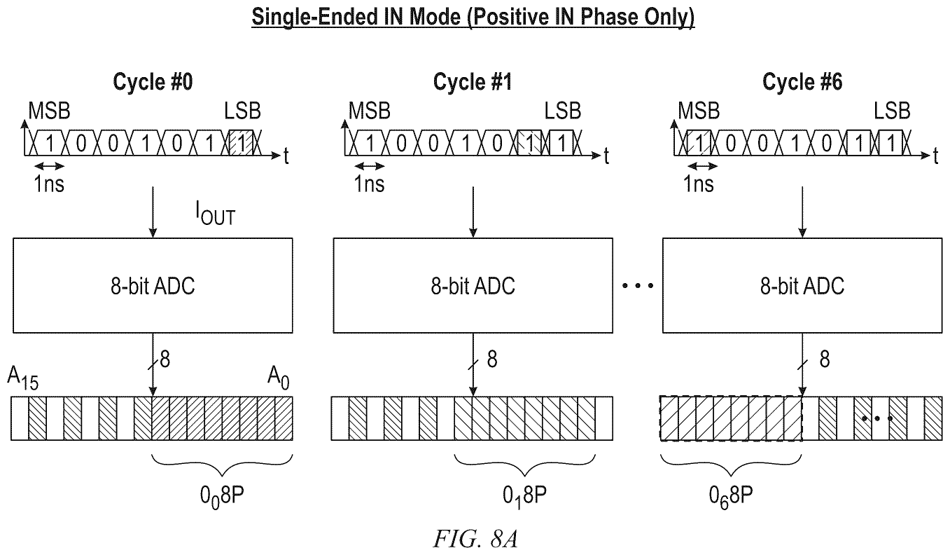

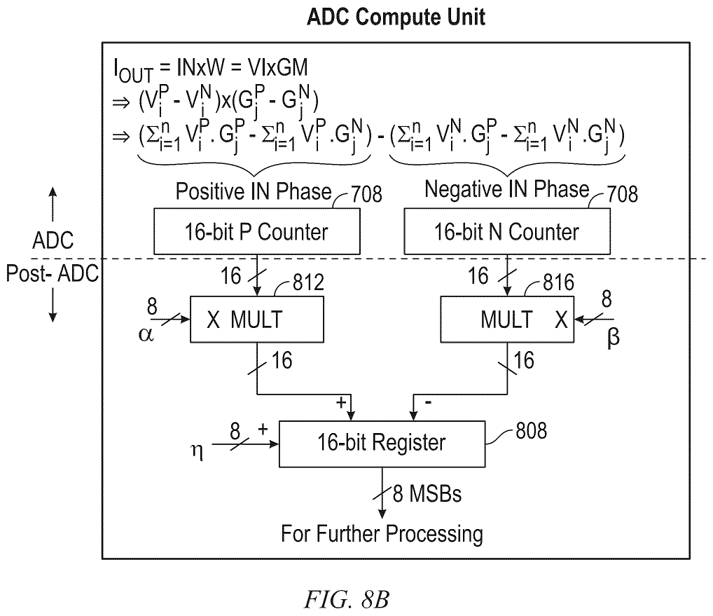

FIG. 8A illustrates the post-processing of the output of the SE-ADC 604. FIG. 8B is a block diagram of an example ADC compute unit for performing post-processing of the output of the increment counter (INC) 708. For post-processing in the case of ΔADC: α and β are scaling factors applied via multipliers 812, 816, respectively, due to the mismatch between P- and N-phase MVMs, known as affine corrections (possibly to match conductance for different polarities) for the crossbar array 220. η_{PN} is an offset mismatch among other ΔADCs in the crossbar array 220 for analog-based computing and is applied via 16-bit register 808.

For post-processing in the case of single-ended ADCs, α=β, as the same set of components are used in positive and negative phases (given MVM is unidirectional). However, the offset mismatch (q) is required.

In the example embodiment of FIG. 8A, each ADC output is 8-bits, depicted by superscript 8P, where P denotes the positive IN phase. Cycle (IN significance bit) is denoted by subscript {0, 1, . . . , 6}.

The result captured at A₁₅-A₀ after 7 cycles is 2⁶×O₆^{8P}+2⁵×O₅^{8P} . . . 2⁰×O₀^{8P} in the positive IN phase. Similarly, in the negative phase, the result accumulated is 2⁶×O₆^{8N}+2⁵×O₅^{8N} . . . 2⁰×O₀^{8N} which is typically subtracted from the results of the first phase with scaling and offset corrections. The final result after two phases in a 16-bit register, A₁₅-A₀, is 2⁶×(α_{P}O₆^{8P}−β_{N}O₆^{8N})+2⁵×(α_{P}O₅^{8P}−β_{N}O₅^{8N}) . . . 2⁰×(α_{P}O₀^{8P}−β_{N}O₀^{8N})+η_{PN}

### Challenges of Input Mapping

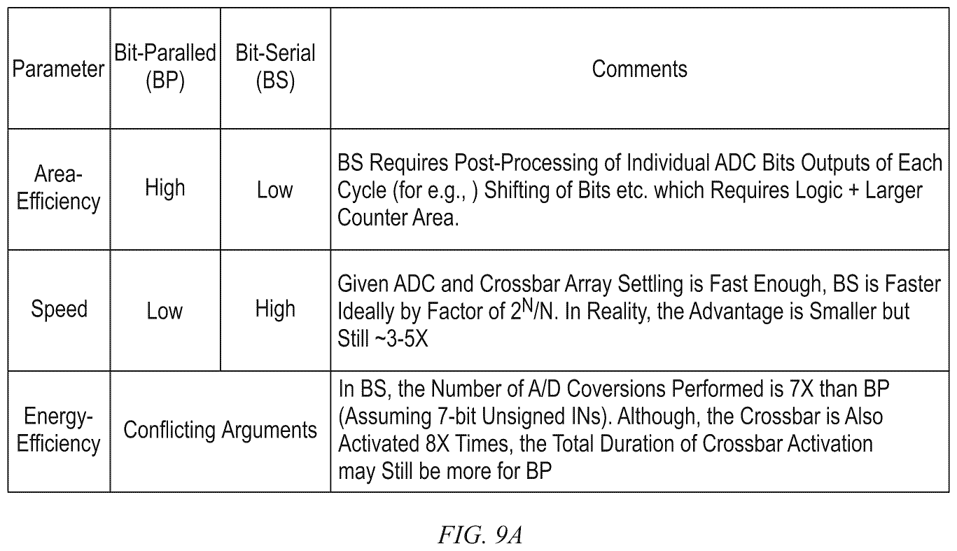

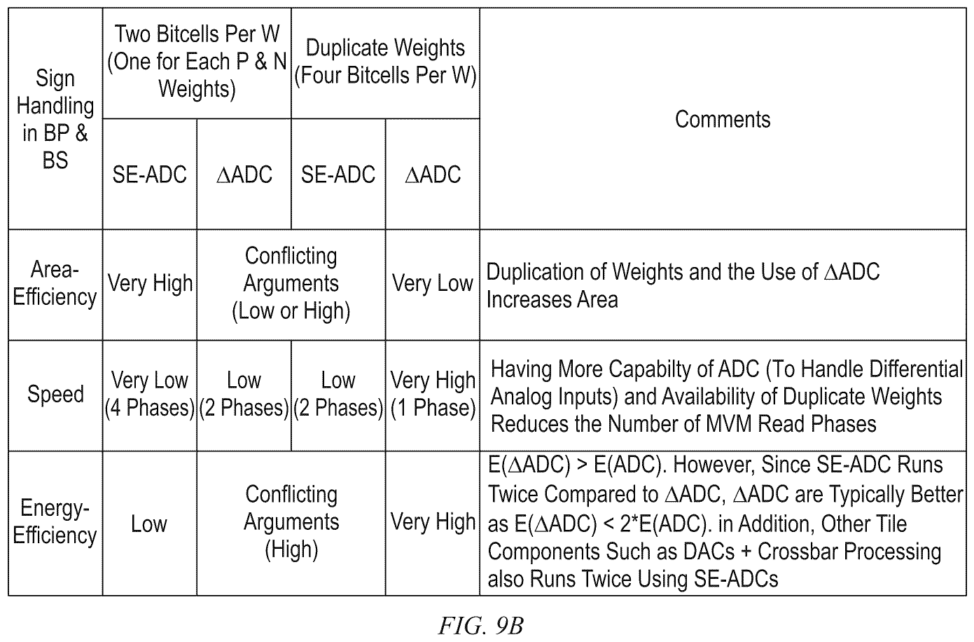

There exists a trade-off between speed, area and energy-efficiency with the following configurations: bit-serial (BS) vs bit-parallel (BP) input mapping schemes. Generally, there is no clear winner. FIG. 9A is a table of remarks regarding speed, area and energy-efficiency for both the bit-parallel and bit-serial configurations. For example, bit-parallel provides high area efficiency and low speed while bit-serial provides low area efficiency and high speed. As noted in FIG. 9A, bit-serial requires post-processing of individual ADC bit outputs of each cycle for, such as, a shifting of bits and the like that requires logic plus more area for the counter 708.

FIG. 9B is a table of remarks regarding speed, area and energy-efficiency for the SE-ADC 604 and ΔADC 608. Sign handling of the data input (INs) is based on the different weight mappings and ADC types (applicable to both bit-serial and bit-parallel). As illustrated in FIG. 9B, for the configuration with two bitcells per weight of the weight matrix W 208, the SE-ADC configuration exhibits very high area-efficiency, very low speed (four phases) and low energy-efficiency. The ΔADC configuration exhibits low speed (two phases), but conflicting arguments for area-efficiency and energy-efficiency.

As illustrated in FIG. 9B, for the configuration with duplicate weights of the weight matrix W 208, the SE-ADC configuration exhibits low speed (two phases), but conflicting arguments for area-efficiency and energy-efficiency. The ΔADC configuration exhibits very low area-efficiency, very high speed (one phase) and very high energy-efficiency.

### Challenges of Weight Mapping and OTA Design

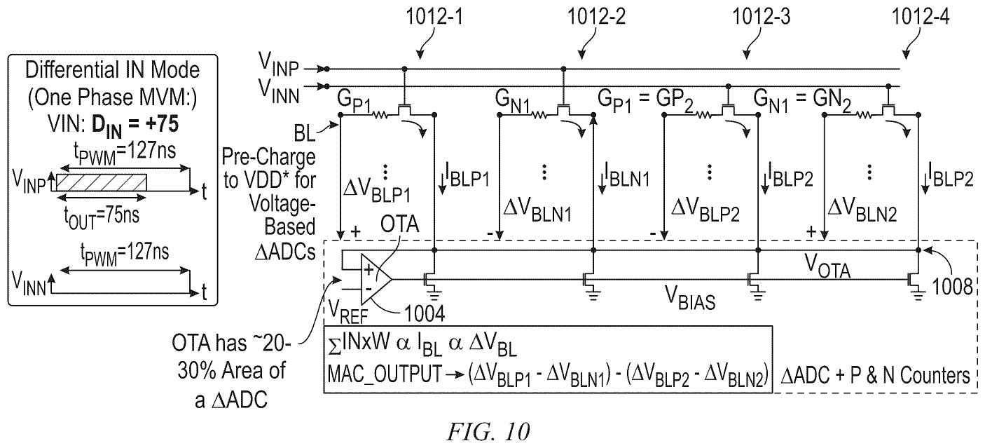

FIG. 10 is a circuit diagram of a voltage-based ADC (voltage sensing configuration). As shown in FIG. 10, to illustrate the operational transconductance amplifier (OTA) functionality, a voltage-based ADC is used with four bit-cells 1012-1, 1012-2, 1012-3, 1012-4 per weight configuration. The functionality remains the same for current-based ADCs and for the case where a weight is represented by two bitcells. It is noted that an OTA 1004 is a large component that attempts to fix the voltage at the BL node 1008 for any current level to create an ideal environment for the bitcell to generate the proportional current for the multiply-accumulate (MAC) output for each column of the crossbar array 220.

Assuming four bit-cells 1012-1, 1012-2, 1012-3, 1012-4 per weight, the OTA 1004 fixes the BL node 1008 to establish a constant voltage drop across the bit-cells 1012-1, 1012-2, 1012-3, 1012-4 for all possible current values. This process is subjected to an error (ε_{BL}=VBL_{ideal}−VBL_{settled}) due to the finite gain of the OTA 1004 and more investment in terms of component sizes (and energy) is required to reduce this error.

In a ΔADC configuration, the OTA 1004 is extended to determine the sign of the resulting analog output of the crossbar array 220 as well. This decides on whether the positive or the negative components of the ADC need to be activated for A/D conversion. This additional task not only introduces more area and energy consumption, but also is prone to inaccuracies due to non-idealities, such as PVT variations.

### Challenges of Post-Processing of A/D Bits

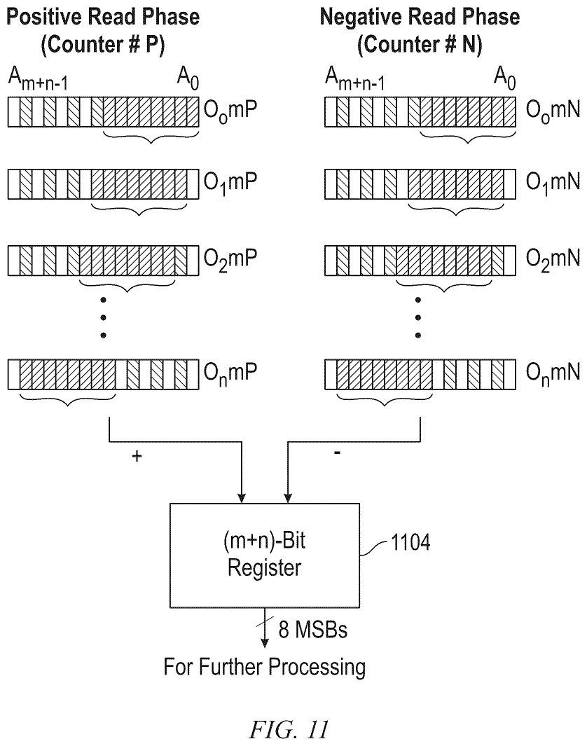

FIG. 11 illustrates the post-processing of the output of the ADCs 604, 608. At the end of each cycle, the value of the counter 708 is shifted by one bit. At the end of a phase, the value of the negative counter is subtracted from the positive counter by an (m+n)-bit register 1104. Although 16-bits are utilized by the counter 708, only 8 bits are typically needed for downstream tasks, assuming that the eight most significant bits are accurately computed. The following challenges exist while performing the post-processing for n-bit data input IN and m-bit ADC output per cycle:
1) area impact;
2) the linear scaling of the size of the counter 708, i.e., m+(n−1)+1→m+n−bit counter (+1 is in case of overflow);
3) the requirement for two such counters: one for capturing positive read outputs and one for capturing negative read outputs (one register is used for storing the result);
4) latency impact; and
5) the linear scaling with n and, typically, exponential scaling with m (roughly n*2^{m}).

In the case of a single phase MVM read (where weights and the ΔADC are duplicated), total latency is n-cycles, where each cycle has a period determined by m-bit ADC latency. The number of cycles increases by a factor of two with 1) non-duplicating weights and 2) using an SE-ADC instead of a ΔADC. The total latency is (n*T_{m-bit ADC})*(2 if !ΔADC)*(2 if !duplicate weights). The energy consumed similarly scales linearly with n and exponentially with m (roughly n*2^{m}).

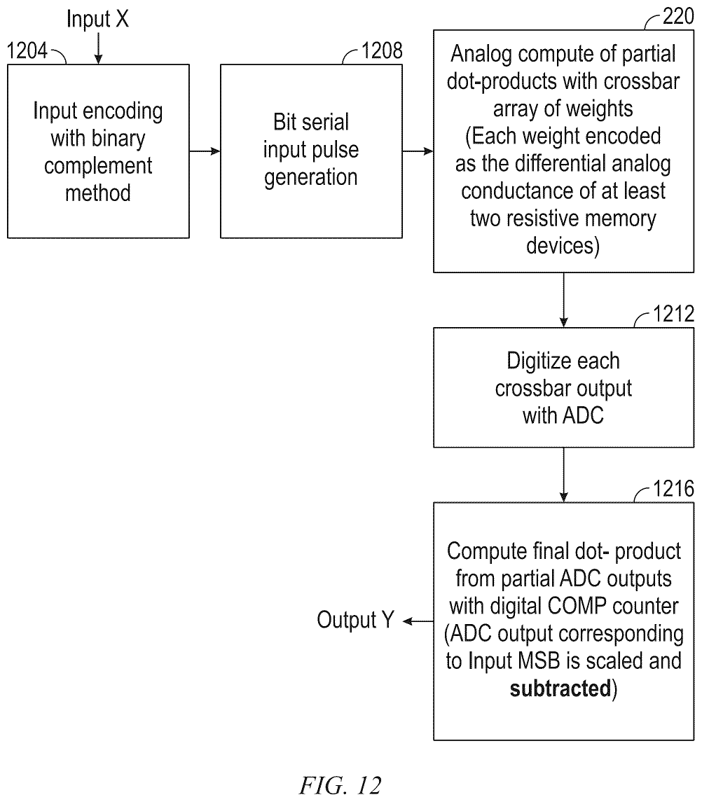

FIG. 12 is a block diagram of an example system for performing in-memory matrix multiplication, in accordance with example embodiments. It is noted that the solution of FIG. 12 is compatible with both analog and digital storage of the weights of the weight matrix W 208. In one example embodiment, an encoder 1204 encodes the input to a binary complementary format (such as ones' complement or two's complement). A pulse generator 1208 performs pulse width modulation on the complementary format of the input data. Each pulse produced by the pulse generator 1208 is applied as a voltage pulse to the crossbar array 220 to compute the partial dot-product in the analog domain. Each weight of the crossbar array 220 is encoded, for example, as the differential analog conductance of at least two resistive memory devices to perform an analog compute of the partial dot-products. The sign bit (such as the most significant bit of the two's complement format of the input data) is applied separately; the remaining bits can be applied in either bit-serial or bit-parallel mode. In one or more embodiments, this advantageously eliminates the need to implement a two-phase process. An ADC 1212 digitizes each output of the crossbar array 220. The partial dot-product results are digitized individually by the ADC 1212. As illustrated in FIG. 12, a digital COMP counter 1216 scales the sign bit and subtracts the negative side of the final output from the positive side, thereby computing the final dot-product result from the partial ADC outputs. The ADC outputs are accumulated into the digital COMP counter 1216 via shift-and-add operations, whereby the ADC output corresponding to the encoded input MSB is scaled and subtracted from the accumulated value of the digital COMP counter 1216. The digital COMP counter 1216 is a counter implemented with, for example, digital flip-flops and associated digital logic with the ability to aggregate partial digital outputs progressively, while accounting for variable significance of the incoming digital bits.

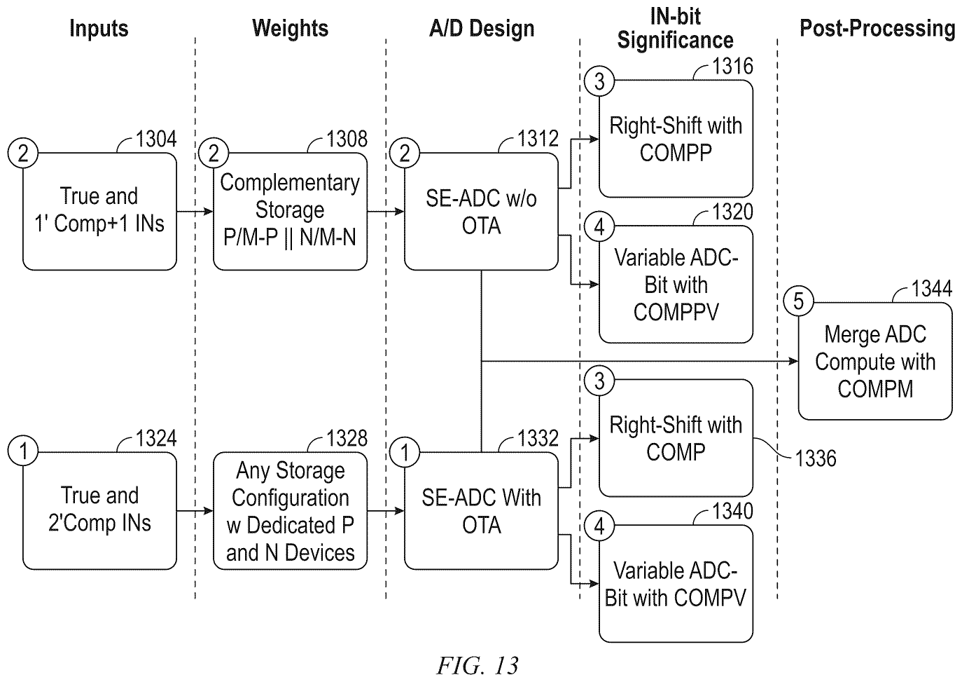

FIG. 13 is a flowchart for determining example viable configurations of the in-memory matrix multiplication architecture of FIG. 12, in accordance with an example embodiment. The input data IN may be, for example, formatted as true and ones' complement plus one (format 1304) or formatted as true and two's complement (format 1324). Complementary storage 1308, such as embodiments where at least two representations of the positive weight and two representations of the negative weight are utilized and where the positive weight is represented by the positive value itself and the complement of that value, is compatible with the true and ones' complement plus one format (format 1304) and with the SE-ADC configuration without an OTA (configuration 1312). The SE-ADC without an OTA is compatible with the right-shift with COMPP counter 1316, the variable ADC-bit with COMPPV counter 1320 and the merge ADC compute with COMPM counter 1344. The COMPP counter 1316 is implemented similar to the digital COMP counter 1216 with the addition of a right-shift mechanism to shred out 1-bit on the rightmost (least significant bit) storage element to account for variable significance of the incoming digital bits. The COMPPV counter 1320 is implemented similar to the COMPP counter 1316 with the addition of a variable ADC-bit mechanism to account for variable significance of the incoming digital bits. The COMPM counter 1344 is implemented similar to the digital COMP counter 1216 with the addition of post-processing with affine scaling (for gain and offset calibration).

Any storage configuration with dedicated positive (P) and negative (N) devices 1328 is compatible with the true and two's complement (format 1324) and with the SE-ADC configuration with an OTA (configuration 1332). The SE-ADC with an OTA is compatible with the right-shift with COMP counter 1336, the variable ADC-bit with COMPV counter 1340 and the merge ADC compute with COMPM counter 1344.

### True and Complementary Data Inputs (INs) Configuration

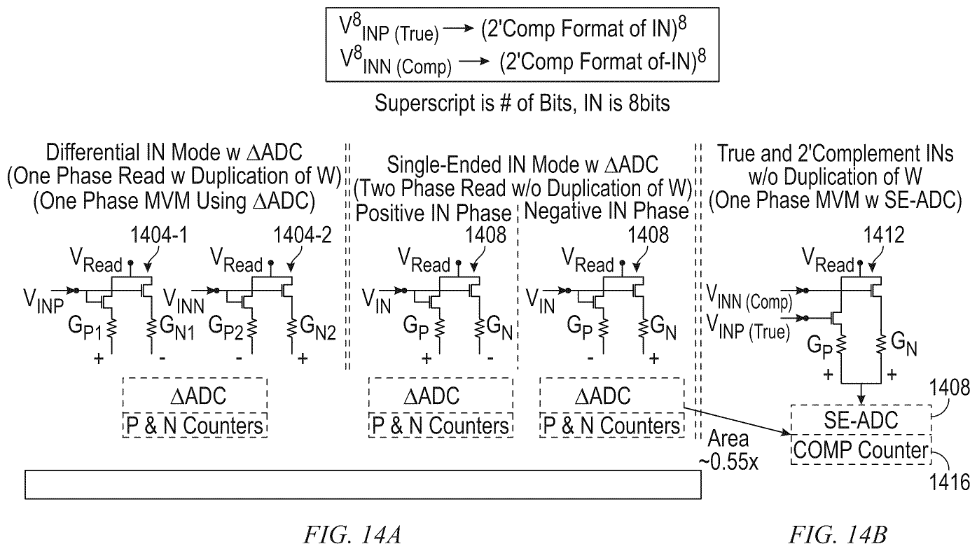

FIG. 14A illustrates conventional single-ended ADC (SE-ADC) and differential ADC (ΔADC) circuits. FIG. 14B illustrates an example single-ended ADC configuration for performing MVM operations, in accordance with an example embodiment. With the differential data input mode with differential ADC (left-side configuration of FIG. 14A), the positive and negative weights are applied to two different circuits 1404-1, 1404-2, allowing the computation in one phase. With the single-ended data input mode with differential ADC (right-side configuration of FIG. 14A), the positive and negative parts of the data input are applied to one circuit 1408 in two different phases: a positive IN phase and a negative IN phase. With the configuration of FIG. 14B, by applying the true value to the positive side and the complementary value to the negative side, the need for duplicate circuits is eliminated while enabling the computation in one phase. Positive and negative counters are not needed; just a single counter 1416. The partial digital results are only required to be added in the digital domain, so there is no need for a subtraction operation (a digital subtraction, however, is performed as a part of the post-processing), there is no need for a differential ADC and there is no need to have separate counters to separately accumulate positive and negative values, since all can be treated as of one sign. Also, 50% sparsity is enforced, meaning the current with be similar for different inputs, resulting in improved SNR and making the calculation more accurate; this also reduces the complexity of the ADC.

In one example embodiment, the complete MVM operation is performed in one phase, using an SE-ADC 1408, by providing the true value and the two's complement value of the input data simultaneously to the P and N analog weights, respectively. This technique is also applicable to digital weights. (Both V_{INP}=true and V_{INN}=two's complement values are in two's complement format.) As the analog inputs to the SE-ADC 1408 are of the same sign, they can be combined and used as a single input to the SE-ADC 1408. In other words, there is no notion of having positive or negative inputs or ADC outputs. Only one counter (COMP counter) 1416 is utilized, but this configuration requires modification of the counter 1416 such that, in the last input bit cycle, i.e., the MSB IN-bit cycle, the ADC output is digitally subtracted from the accumulated ADC outputs. In the rest of the IN-bit cycles, the counter 1412 is incremented (shifting and adding ADC outputs to the counter 1412) as usual, as described in FIGS. 7, 8A and 8B. Therefore, in the bit-serial mode, the final MVM output is:

$$- {2}^{7} \times {O}_{7}^{8} + ( {2}^{6} \times {O}_{6}^{8} + {2}^{5} \times {O}_{5}^{8} ... {2}^{0} \times {O}_{0}^{8} )$$

It is worth noting that, while using two's complement for the weights and data input (IN) is conventional, such implementations are restricted or are applicable to only the configuration where weights are stored as digital bits, whereas one or more exemplary embodiments are applicable to both digital and analog storage. One restriction is that the way outputs are handled in the periphery is only applicable to digital storage elements; this is because previously only the true input data is applied the same to both positive and negative weights whereas, in example embodiments, the true form is provided to positive weights and the complementary form to negative weights. Also, conventional techniques perform two's complement compute using two's complement data input and/or weights, which requires the digital circuitry in the periphery to translate from two's complement form back to integer form.

### Advantages

Compared to conventional techniques with a single MVM read phase capability for analog weights, one or more embodiments advantageously obviate the need for:
duplication of weights: only P and N weights are required, resulting in an expected area and power improvement;
a differential ADC as no subtraction by the ADC is needed: an SE-ADC may be used with an expected area and power improvement;
both P and N counters: only one COMP counter is required with an expected area improvement;
the need to adjust the dynamic range of the ADC, since the maximum current remains the same due to the ˜50% data input (IN) bit-sparsity of true and two's complement data inputs (INs); and
drastically reduces an occurrence probability of V_{OUT} or V_{OUT} being approximately 0, which further simplifies the ADC design.
   True and Complementary Weights with One-Complementary+1 Data Input (IN)

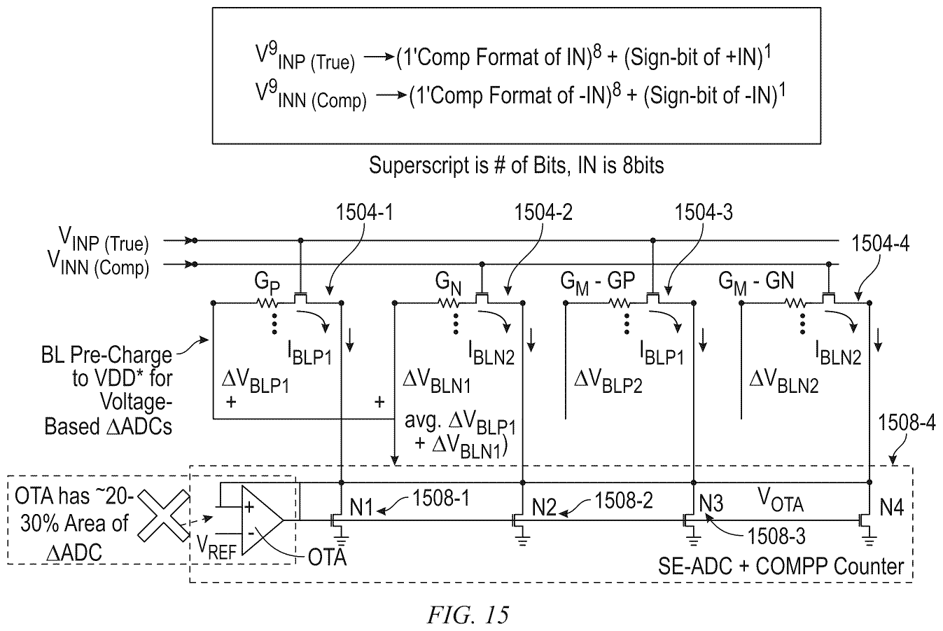

FIG. 15 illustrates another example single-ended ADC configuration for performing MVM operations, in accordance with an example embodiment. One pertinent aspect is to eliminate the need for the OTA 1004 by balancing the current (Iₜₒₜ) going into the OTA 1004 such that the Iₜₒₜ is independent of the data input (IN) and weight values.

Again, similar to the embodiment of FIG. 14, this configuration enables a one phase MVM read while using a SE-ADC. This configuration is also applicable to digital weights. As the analog inputs to the ADC are of the same sign, they can be combined and used as a single input into the SE-ADC. In other words, similar to the embodiment of FIG. 14, there is no notion of having positive or negative inputs or ADC outputs. In one or more embodiments, this requires two modifications to perform a complete MVM in a single phase with bit-serial IN mode:

Both a true value and a ones' complement value of the data input (IN) (i.e., bit-wise complement of the true data input (IN) bits) are provided simultaneously to P and N weights (bitcells 1504-1, 1504-2, 1504-3, 1504-4), respectively. One additional cycle with the data input IN-bit set to +1 is required to convert the ones' complement of the data input IN into a two's complement of the data input IN; hence, the term “ones' complement+1” is used. Whichever value is negative (the V_{INP} true value or the V_{INN} ones' complement value) has an additional+1 LSB to become a two's complement number. So, in that additional (+1) cycle, the positive data input (IN) will have a V_{INP}=0 and V_{INN}=VDD, and the negative data input (IN) will have V_{INP}=VDD and V_{INN}=0. In other words, both V_{INP} and V_{INN} are in ones' complement+1 format.

The four bitcells 1504-1, 1504-2, 1504-3, 1504-4 per weight are required in one or more embodiments. Storing a complementary weight implies storing the target conductance G_{P} and storing the G_{M}−G_{P} conductance on two devices. Similarly, G_{N} and G_{M}−G_{N} are stored. Here, G_{M} is the maximum conductance a device can be programmed to.

Only one counter (COMPP counter) is required. In addition to the modifications required for the embodiment of FIG. 14, (i.e., in MSB IN-bit cycle, the ADC output is subtracted from the accumulated ADC outputs, while in the rest of the IN-bit cycles, the counter is incremented), in the one additional cycle with data input IN set to +1 as described above, the ADC output corresponding to this is added to the accumulated ADC outputs in the COMPP counter.

In the bit-serial mode, the final MVM output is:

$$- {2}^{7} \times {O}_{7}^{8} + ( {2}^{6} \times {O}_{6}^{8} + {2}^{5} \times {O}_{5}^{8} ... {2}^{0} \times {O}_{0}^{8} ) + {2}^{0} \times {O}_{8}^{8}$$

As the total current going into the footer NMOS transistors N1-N4 of the bitcells 1508-1, 1508-2, 1508-3, 1508-4 is always constant, voltage node V_{OTA} does not require an OTA 1004 to fix its voltage for performing the MVM operation. The OTA 1004 is already not required to determine the sign of the ADC inputs as the notion of positive or negative inputs is eliminated. This implies the OTA 1004 can be completely removed to enable a less expensive ADC design.

Using complementary weights and data inputs (IN) is a conventional technique, but such conventional use is restricted or is applicable to only weights stored as digital bits, whereas one or more exemplary embodiments are applicable to both digital and analog storage, and use a “ones' complement+1” approach. As noted above, one restriction is that the way outputs are handled in the periphery is only applicable to digital storage elements; this is because previously only the true data input is applied the same to both positive and negative weights whereas, in example embodiments, the true form is provided to positive weights and complementary form to negative weights. Also, conventional techniques perform two's complement compute using two's complement data input and/or weights, which requires the digital circuitry in the periphery to translate from two's complement form back to integer form. In conventional techniques, an OTA 1004 is always needed to ensure a fixed reference voltage node. The results in these conventional configurations using two's complement digital weights and data inputs (IN) have a two's complement output as the ADC output. It is similar to a digital computing block multiplying two two's complement input values, where inputs need sign extensions as a pre-processing step. However, one or more exemplary embodiments generate a signed output (where the MSB represents the sign and the remaining bits are for the magnitude) for analog weights.

Compared to conventional circuits with a single MVM read phase capability for analog weights, example embodiments advantageously:
obviate the need for a differential ADC, eliminating the need to perform a subtraction operation (only an SE-ADC is required resulting in expected area and power improvements);
provide OTA 1004 within an SE-ADC which results in expected area and power improvements;
obviate the need for both P and N counters: only one COMP-counter is required resulting in expected area improvement;
obviate the need for adjustments to the dynamic range of an ADC since the maximum current remains constant due to an ˜50% data input (IN) bit-sparsity of true and two's complement data inputs (INs); and
drastically reduce an occurrence probability of V_{OUT} or V_{OUT} being approximately zero, which further simplifies the ADC design.

### Right-Shift Configurations

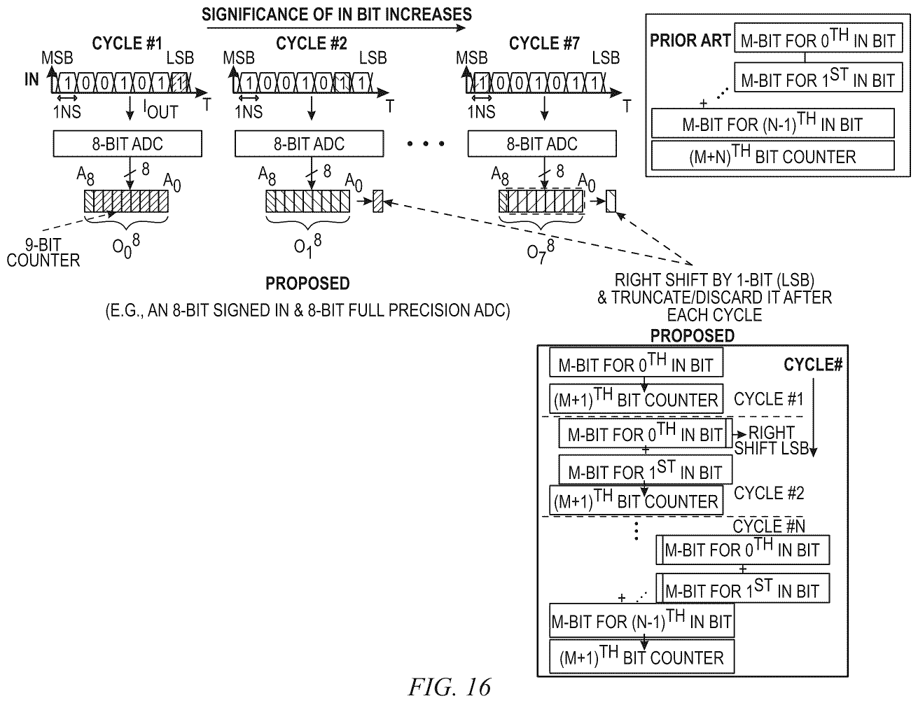

FIG. 16 illustrates three cycles of a right-shift operation that enables a reduction in the size of the counter 1416, in accordance with example embodiments. A pertinent aspect here is to reduce the counter size. The IN-bit significance is taken care of by a right-shift and truncation of the LSB during each cycle. It is applicable to both positive and negative read phases (with or without using the embodiments of FIGS. 14 and 15) with an SE-ADC, a differential ADC, and the like. With this configuration, the size of the counter 1416 is reduced from (m+n)-bits to essentially (m+1)-bits.

After each MVM cycle, including the analog-to-digital (A/D) conversion, a 1-bit right-shift is performed in the counter and, during the next cycle, the A/D outputs increment the counter as usual. In the case of the n^{th} cycle (for either the embodiment of FIG. 14 or FIG. 15), the (n−1)^{h} output is not right-shifted, the n^{th} cycle output is left-shifted by one bit and a final result of the shifting operations is subtracted from the counter value. Then, a smaller number of bits, such as the eight most significant bits of the counter, are transferred for further processing.

### Variable ADC-Bits

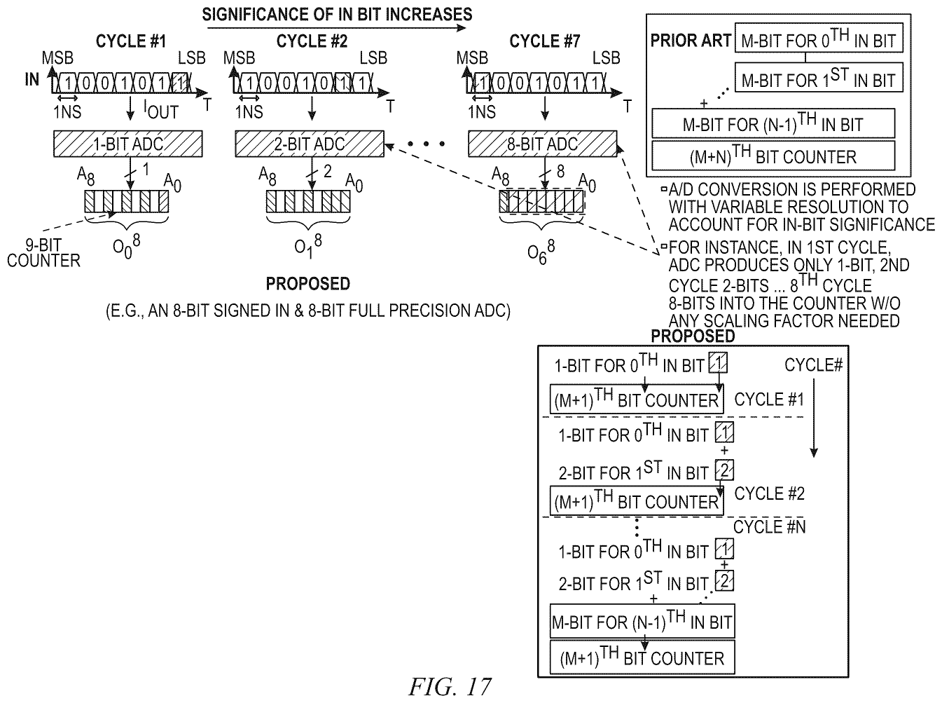

FIG. 17 is an example architecture for reducing the size of the counter, in accordance with an example embodiment. As noted, the key focus is to reduce the size of the counter, and the consumption of analog-to-digital (A/D) energy and latency. The IN-bit significance is taken care of by performing variable A/D bit conversions during each cycle, i.e., incrementing the resolution by 1-bit. It is applicable to both positive and negative read phases (with or without using the embodiments of FIG. 14 or FIG. 15) with a SE-ADC, a differential ADC, and the like. The final result for bits A₈-A₀ is −2*O₇⁸+O₆⁷ . . . O₀¹. With this, the following reductions are attained:
a reduction in the size of the counter from (m+n)-bits to essentially (m+1)-bits; and
a reduction in the cumulative A/D conversion energy and latency for the entire MVM operation as the reduced precision saves power, from a factor of n*2^{m} to 2¹+2² . . . 2^{m}≈2*2^{m}≈2^{(m+1)}.

After each MVM cycle, the bit-resolution of the A/D operation is increased by 1-bit to account for the IN-bit significance (the right-shift comes for no cost.)

In either the embodiment of FIG. 14 or 15, during the n^{th} cycle, the outputs (n−1)^{th} are 8-bits and the n^{th} cycle output (also 8-bits) is left-shifted by one bit and is subtracted from the counter value. Then, a smaller number of bits, such as the eight most significant bits, are transferred for further processing. Thus, as opposed to the right-shift operation of FIG. 16, there is no shifting; instead, one bit is provided for the first cycle, two bits for the second cycle, and so on, where the more significant bits generate more counter bits.

### ADC Compute

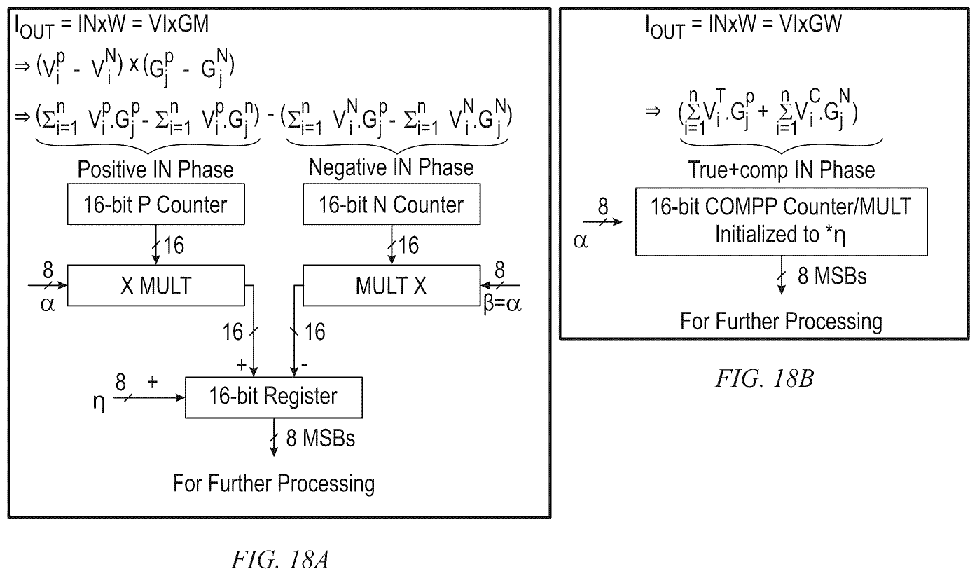

FIG. 18A is a block diagram of a conventional ADC compute configuration. FIG. 18B is a block diagram of an example ADC compute configuration, in accordance with example embodiments. A pertinent aspect of the example embodiment of FIG. 18B is to merge certain post-processing tasks and ADC counter tasks to simplify the counter and the ADC compute unit. In post-processing with the SE-ADC configuration:
since α=β, multiplication of a can be easily implemented by adding additional functionality to the COMP counter;
an offset mismatch (η) is still required, but is taken care of by the COMPM counter.

The counter is initialized with *η_{PN} (*η=η/α). With this configuration, the following replacements are made when used in conjunction with the embodiments of FIGS. 14 and 15: two counters, two multiply units and a register by a single COMPM counter with a multiply capability.

The counter is initialized with a new offset mismatch factor (*η=η/α) before the processing of MVM. During the MVM read phase, accumulating is performed for 8/9 cycles in a 16-bit counter. After digitization of the analog MVMs is completed, the scaling factor α is applied to the counter. Then, a smaller number of bits, such as the eight most significant bits, are transferred for further processing.

Advantageously, the example embodiment of FIG. 14:
provides true and two's complement data input (INs);
obviates the need for the duplication of weights;
obviates the need for the differential ADC and both P and N counters in the SE-ADCs;
drastically reduces the probability of having I_{colm}˜0; and/or
eliminates the notion of having positive or negative outputs.

Advantageously, the example embodiment of FIG. 15:
provides true and complementary weights with true and ones' complement+1 data input (INs);
obviates the need for an OTA 1004 (in voltage- or time-based ADCs) and the need for sign-detection;
obviates the need for a differential ADC and both the P and N counters in SE-ADCs;
drastically reduces the probability of having I_{colm}˜0; and
eliminates the notion of having positive or negative outputs.

Advantageously, right-shift embodiments reduce the size of the counter from (m+n)-bits to essentially (m+1)-bits.

Advantageously, variable A/D Bit Resolution embodiments reduce the counter size, and reduce the cumulative A/D conversion energy and latency for the entire MVM operation.

Advantageously, merge ADC Compute embodiments replace the need for two counters, two multiply units and a register with a single COMPP counter with a multiply capability for any MVM-type operation.

### Split PWM Approach

In one example embodiment, a split PWM approach implements a hybrid of the bit-serial and the bit-parallel schemes to perform digital-to-time conversion (DTC) of the data input (INs). The split PWM approach is applicable to both a sign-magnitude format of the data input and a two's complement format of the data input.

In one example embodiment of the split PWM approach, the bits corresponding to the magnitude of the data input I₆-I₀ can be divided into an arbitrary number of groups and arbitrary group size, and these can be applied to the crossbar array 220 separately, while the sign bit I₇ is applied as another separate pulse. In other words, the split PWM approach only splits the magnitude bits and not the sign bit, where this sign bit is separately applied along with the required scaling factor on its corresponding output O₇.

One important consideration is to associate the proper scaling factor to the outputs corresponding to the data input bits. The manner in which the magnitude bits of the data input split into different groups determines the scaling factor, such that the individual bits maintain the same factor as described by the original bit-serial case, as given by:

$$- {2}^{7} \times {{O}_{7}}^{8} + ( {2}^{6} \times {{O}_{6}}^{8} + {2}^{5} \times {{O}_{5}}^{8} + {2}^{4} \times {{O}_{4}}^{8} + {2}^{3} \times {{O}_{3}}^{8} + {2}^{2} \times {{O}_{2}}^{8} + {2}^{1} \times {{O}_{1}}^{8} + {2}^{0} \times {{O}_{0}}^{8} )$$

For instance, when using current-controlled oscillator (CCO)-based ADCs where the duration of the data input pulse regulates the number of pulses (hence, acting as an amplification factor to the digital output), this required scaling factor in the split PWM mode is taken care by a combination of the pulse duration and a post-adjusted scaling factor while the partial sum of ADC outputs are accumulated.

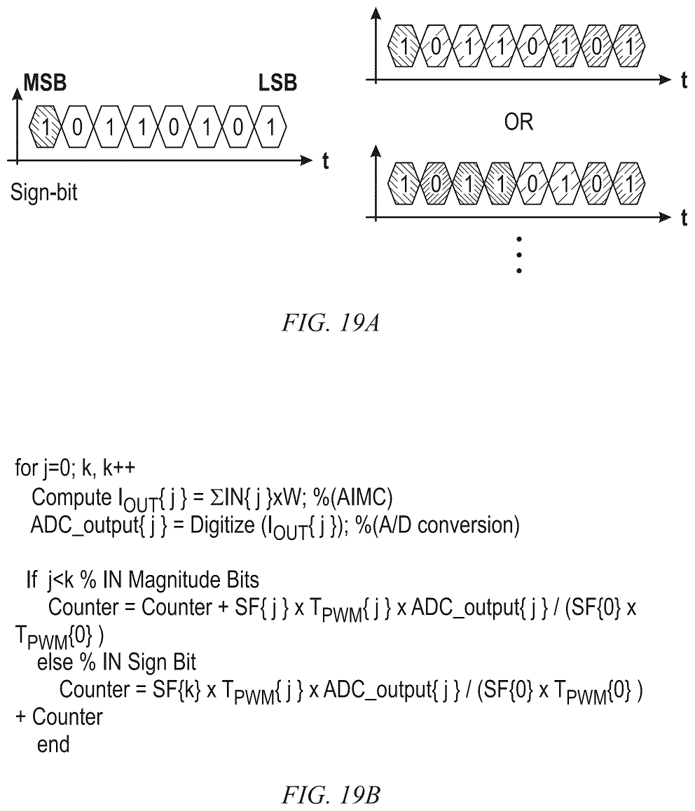

FIG. 19A illustrates two examples of a split pulse width modulation (PWM) approach, in accordance with example embodiments. For the case where the split of the 7-bit magnitude is 4 most significant bits (MSBs) and 3 least significant bits (LSBs) (top example of FIG. 19A), the duration of pulses for the MSB and LSB can be in the same ratio as the number of bits; a 4-bit MSB with a 16 ns pulse duration and a 3-bit LSB with an 8 ns pulse duration. A scaling factor of 8 must be applied to the output corresponding to the most significant bits since there are 3 LSBs. The sign bit has a 32 ns pulse duration and the output corresponding to it must be subtracted from the accumulated summation of scaled outputs corresponding to the 4-bit MSB and the 3-bit LSB.

In another example (bottom example of FIG. 19A), the sign bit is I₇ and I₆-I₀ is split into 4 parts, such as I₆, I₅-I₄, I₃-I₂, I₁-I₀ (of 1 bit, 2-bits, 2-bits, 2-bits). If unequal durations are used for the four parts and different ratios are used than the significance of bits, the scaling factor is given by:
O₇ (sign-bit I₇ with a 32 ns duration) must have a scaling factor of −8;
O₆ (I₆ with a 32 ns duration) must have a scaling factor of 4;
O₅-O₄(I₅-I₄ with an 8 ns duration) must have a scaling factor of 4;
I₃-I₂ (I₃-I₂ with an 8 ns duration) must have a scaling factor of 1;
I₁-I₀ (I₁-I₀ with a 2 ns duration) must have a scaling factor of 1; and

−8*32*xO₇⁸+4*32*(2⁰xO₆⁸)+4*8*(2¹xO₅⁸+2⁰xO₄⁸)+8*1*(2¹xO₃⁸+2⁰xO₂⁸)+2*1*(2¹xO₁⁸+2⁰xO₀⁸)/2*1.

Assuming that a signed data input includes m=8 bits ([I₇-I₀]), where I₇ is a sign bit and I₆-I₀ is the magnitude, I₆-I₀ is split into k groups. ADC_output{j} is the 8-bit output in the j¹ cycle, corresponding to the jth group.

FIG. 19B describes an algorithm to accommodate IN significance in the pre- and post-processing of the ADC results, in accordance with example embodiments. This accommodation can be performed by scaling the corresponding ADC output ADC_output{j} with a combined factor of T_{PWM}{j} (integration time applied as a pre-processing scheme for the corresponding IN bits involved in generating ADC_output{j} in the cycle j) multiplied by a scaling factor (SF{j}), such that T_{PWM}{j}×SF{j}) correctly accommodates the required scaling. Here, the correct scaling is a fixed value known prior to performing the MVM operation. Note that SK{k} corresponding to the sign bit is a negative value, and this sign bit of IN must always be applied separately, whereas the rest of the bits (the magnitude bits, here, 7 bits) can be segmented into any combination or groups of bits (all separate as in bit-serial mode, all together as in bit-parallel mode, or in the described split mode).

### Validation: Simulation Results

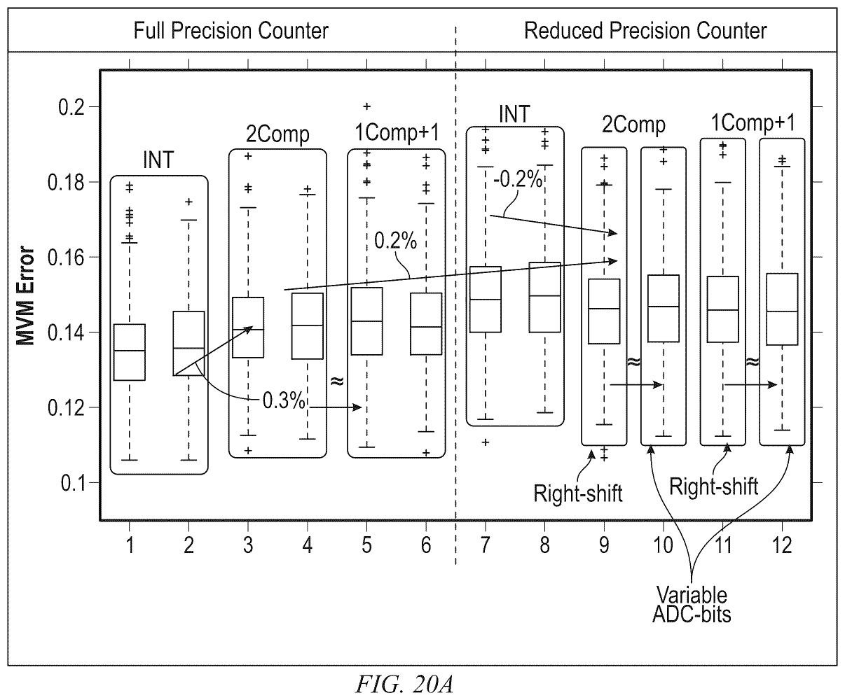

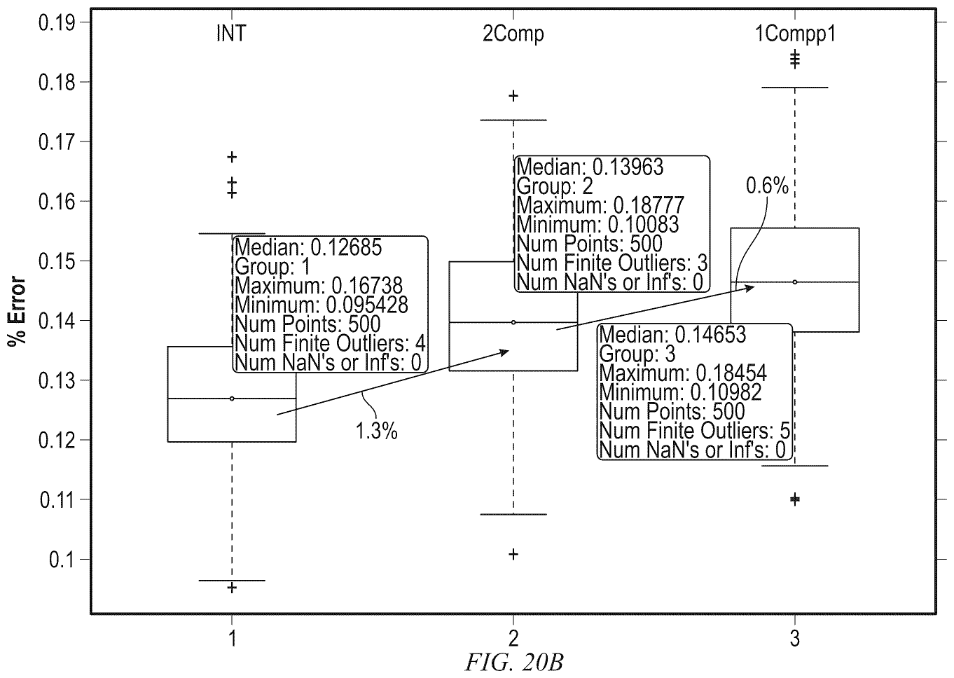

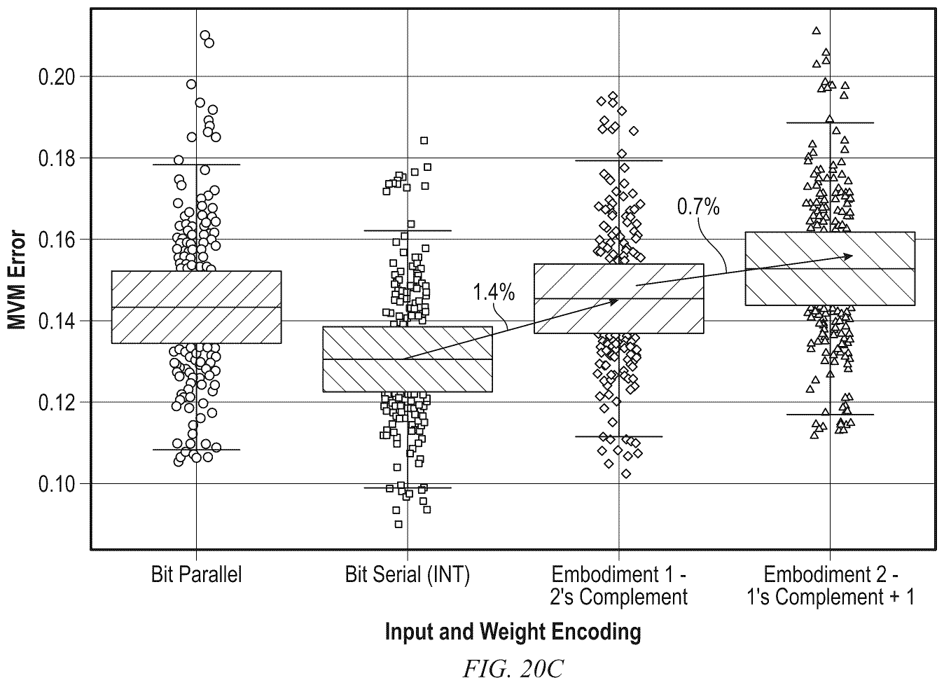

FIG. 20A illustrates the results of simulations using a conventional programming and numeric computing platform, in accordance with example embodiments. The results of FIG. 20A include experimentally verified PCM programming errors for a crossbar array 220 of size 512×512, an IN vector of size 512×1 (each element of size 8-bits) and a weight matrix W 208 of size 512×512 (each element of size 8-bits). In the simulations of FIG. 20A, 1,000 MVM operations were performed in a single phase with random data input (INs) and weights using the following configurations: INT with a differential ADC and P and N duplicate weights (4 devices); two's complement format was used with a SE-ADC and P & N weights (2 devices) (2′comp; #1); and ones' complement format SE-ADC* with duplicate weights (4 devices) (1′comp+1; #2). Most of the error percentage is the result of programming noise, and a small percentage from floating to integer (INT) conversion of the data input (INs) and weights. In most cases, this absorbs the potential errors coming from the IN configuration or precision of the counter (0.4%˜1 LSB error in an 8-bit ADC). One variation is due to digital-to-analog conversion. In some cases, it is digital to time domain where each bit, ideally of equal size, can be slightly different. This can cause some errors in the MVM output.

### Precision

Conventional solutions, as described above, typically use a 16-bit counter to implement full precision. In the example embodiments of FIGS. 16 and 17, a 9-bit counter provides a precision that is more accurate than the precision that would be obtained when reducing a 16-bit counter to a 9-bit counter in the conventional solution. In particular, the MVM error percentage exhibits an increase of 0.3% compared to INT using a full precision counter for the embodiments of FIGS. 14 and 15. Similarly, the MVM error percentage exhibits an increase of 0.5% compared to INT using full precision counter for the embodiments of FIGS. 16 and 17.

Validation: Simulation Results with Read Noise

FIGS. 20A-20B illustrates results of simulations using the conventional programming and numeric computing platform including experimentally-verified PCM programming errors, in accordance with example embodiments. The results of FIGS. 20A-20B include experimentally verified PCM programming errors for a crossbar array 220 of size 512×512, an IN vector of size 512×1 (each element of size 8-bits) and a weight matrix W 208 of size 512×512 (each element of size 8-bits).

In the simulations of FIG. 20B, 1,000 MVM operations were performed in a single phase with random data input (INs) and weights using the following configurations: INT with a differential ADC and P and N duplicate weights (4 devices); two's complement format was used with a SE-ADC and P & N weights (2 devices) (2′comp; #1); and ones' complement format SE-ADC* with duplicate weights (4 devices) (1′comp+1; #2). Most of the error percentage is the result of programming noise, and a small percentage from floating-to-integer (INT) conversion of the data input (INs) and weights. Random read noise is added on top of PCM programming noise, which has a random value in each compute cycle that captures random PCM noise during the entire MVM operation.

As illustrated, using two's complement with the embodiment of FIG. 14, the MVM error percentage increases 1.3% compared to INT using a full precision counter. Also, as illustrated, using ones-complement+1 with the embodiment of FIG. 15, the MVM error percentage increases 1.9% compared to INT using a full precision counter.

### Validation: Experimental Results

FIG. 20C illustrates results of simulations using a PCM-based IMC core, in accordance with example embodiments. The hardware comprises a 256×256 PCM array and a conventional ADC. 5,000 MVMs were performed with the configurations as follows:
bit parallel mode with multibit PWM inputs and two devices per weight;
bit serial (INT) mode with bit-sliced input and four devices per weight (weight duplication);
two's complement: true and two's complement input with two devices per weight; and
ones' complement+1: true and ones' complement input plus the sign bit with two devices per weight (the Gm−Gp/Gn were not programmed in the experiment due to hardware constraints).

The embodiment of FIG. 14 exhibited a mean MVM error that increased by ˜1% compared to INT and ˜0.5% compared to bit-parallel.

The embodiment of FIG. 14 exhibited a mean MVM error that increased by ˜0.5% compared to the embodiment of FIG. 14. Possibly explained by the addition of one new phase on the input (nine bits instead of eight bits).

Given the discussion thus far, it will be appreciated that, in general terms, an exemplary device, according to an aspect of the invention, includes a matrix-vector multiplication device comprising an input encoder 1204 that encodes an input vector into a binary complement format value and a binary true format value; a pulse generator 1208 that converts each encoded bit of the binary complement format value and each encoded bit of the binary true format value into a corresponding pulse signal; a crossbar array of weights 220, wherein each weight is encoded as a differential analog conductance of at least two resistive memory devices, wherein the pulse generator 1208 simultaneously applies at least one pulse signal corresponding to a given encoded bit of the binary complement format value to a corresponding resistive memory device of the at least two resistive memory devices and at least one pulse signal corresponding to a given encoded bit of the binary true format value to a corresponding resistive memory device of the at least two resistive memory devices; an analog-to-digital converter 1212 that digitizes outputs of the crossbar array of weights 220 to generate partial dot-product results; and a digital COMP counter 1216 that computes a final dot-product result from the partial dot-product results.

In one example embodiment, each pulse signal produced by the pulse generator 1208 is applied as a voltage pulse to the crossbar array 220 to compute a corresponding one of the partial dot-product results in an analog domain.

In one example embodiment, each of the partial dot-product results are digitized individually by the analog-to-digital converter 1212.

In one example embodiment, outputs of the analog-to-digital converter 1212 are accumulated into the digital COMP counter 1216 via shift-and-add operations, whereby the outputs of the analog-to-digital converter 1212 corresponding to sign bits of the encoded input vector is scaled and subtracted from an accumulated value of the digital COMP counter 1216. (See, FIG. 14B.)

In one example embodiment, each weight encoded as the differential analog conductance is stored via four bitcells 1504-1, 1504-2, 1504-3, 1504-4, the weights including a target conductance G_{P}, a conductance G_{M}−G_{P}, a conductance G_{N} and a conductance G_{M}−G_{N}. (See, FIG. 15.)

In one example embodiment, the digital COMP counter 1216 comprises a multiplication capability to apply a scaling factor α to a value stored in the digital COMP counter 1216 and an offset mismatch f is handled by the digital COMP counter 1216 by initializing the digital COMP counter 1216 with an initialization value defined by *η_{PN} (*η=η/α). (See, FIG. 18B.)

In one example embodiment, the digital COMP counter 1416 is configured to perform a right-shift operation and a truncation of the least significant bit during one or more first-type cycles; abstain from performing the right-shift operation for one second-type cycle; and perform a left-shift operation for one cycle and the truncation of the least significant bit during a third-type cycle. (See, FIG. 16.)

In one example embodiment, the digital COMP counter 1416 is configured to subtract a final result of the shift operations from a counter value of the digital COMP counter 1416 after performance of the third-type cycle and wherein only a proper subset of bits of the digital COMP counter 1416 are configured to be transferred for further processing.

In one example embodiment, the digital COMP counter 1416 is configured to add a value of a least significant bit from the partial dot-product results in a first cycle, configured to add a value of two least significant bits from the partial dot-product results in a second cycle, and is configured to add a value of three least significant bits from the partial dot-product results in a third cycle, and wherein a bit-resolution of an operation of the analog-to-digital converter 1212 is increased by 1-bit after each cycle to account for an IN-bit significance. (See, FIG. 17.)

In one aspect, a matrix-vector multiplication device comprises an input encoder that encodes an input vector into a binary complement format value and a binary true format value; a pulse generator 1208 that converts each of one or more sets of bits of the encoded binary complement format value and each of one or more sets of bits of the encoded binary true format value into a corresponding pulse signal; a crossbar array of weights, wherein each weight is encoded as a differential analog conductance of at least two resistive memory devices, wherein the pulse generator 1208 simultaneously applies at least one pulse signal corresponding to a given set of the sets of bits of the encoded binary complement format value to a corresponding resistive memory device of the at least two resistive memory devices and at least one pulse signal corresponding to a given set of the sets of bits of the encoded binary true format value to a corresponding resistive memory device of the at least two resistive memory devices; an analog-to-digital converter 1212 that digitizes outputs of the crossbar array of weights to generate partial dot-product results; and a digital COMP counter 1216 that computes a final dot-product result from the partial dot-product results.

In one example embodiment, a count of pulses generated by the pulse generator 1208 for the encoded binary complement format value and a count of pulses generated by the pulse generator 1208 for the encoded binary true format value is a same count value.

In one example embodiment, each output of the analog-to-digital converter 1212 corresponding to one of the sets of bits is multiplied by a corresponding predetermined scaling factor and accumulated into the digital COMP counter 1216.

In one example embodiment, the pulse generator 1208 converts a sign bit of the encoded binary complement format value and a sign bit of the encoded binary true format value into corresponding sign pulse signals.

In one example embodiment, the outputs of the analog-to-digital converter 1212 corresponding to the sign bit of the encoded binary complement format value and the sign bit of the encoded binary true format value are scaled and subtracted from an accumulated value of the digital COMP counter 1216.

In one aspect, a hardware description language (HDL) design structure is encoded on a machine-readable data storage medium, the HDL design structure comprising elements that when processed in a computer-aided design system generates a machine-executable representation of a semiconductor structure, wherein the HDL design structure comprises an input encoder 1204 that encodes an input vector into a binary complement format value and a binary true format value; a pulse generator 1208 that converts each encoded bit of the binary complement format value and each encoded bit of the binary true format value into a corresponding pulse signal; a crossbar array of weights 220, wherein each weight is encoded as a differential analog conductance of at least two resistive memory devices, wherein the pulse generator 1208 simultaneously applies at least one pulse signal corresponding to a given encoded bit of the binary complement format value to a corresponding resistive memory device of the at least two resistive memory devices and at least one pulse signal corresponding to a given encoded bit of the binary true format value to a corresponding resistive memory device of the at least two resistive memory devices; an analog-to-digital converter 1212 that digitizes outputs of the crossbar array of weights 220 to generate partial dot-product results; and a digital COMP counter 1216 that computes a final dot-product result from the partial dot-product results.

In one aspect, a hardware description language (HDL) design structure is encoded on a machine-readable data storage medium, the HDL design structure comprising elements that when processed in a computer-aided design system generates a machine-executable representation of a semiconductor structure, wherein the HDL design structure comprises an input encoder that encodes an input vector into a binary complement format value and a binary true format value; a pulse generator that converts each of one or more sets of bits of the encoded binary complement format value and each of one or more sets of bits of the encoded binary true format value into a corresponding pulse signal; a crossbar array of weights, wherein each weight is encoded as a differential analog conductance of at least two resistive memory devices, wherein the pulse generator simultaneously applies at least one pulse signal corresponding to a given set of the sets of bits of the encoded binary complement format value to a corresponding resistive memory device of the at least two resistive memory devices and at least one pulse signal corresponding to a given set of the sets of bits of the encoded binary true format value to a corresponding resistive memory device of the at least two resistive memory devices; an analog-to-digital converter that digitizes outputs of the crossbar array of weights to generate partial dot-product results; and a digital COMP counter that computes a final dot-product result from the partial dot-product results.

The skilled artisan can synthesize a digital circuit in the desired logic family to carry out the above functions, as described more fully below.

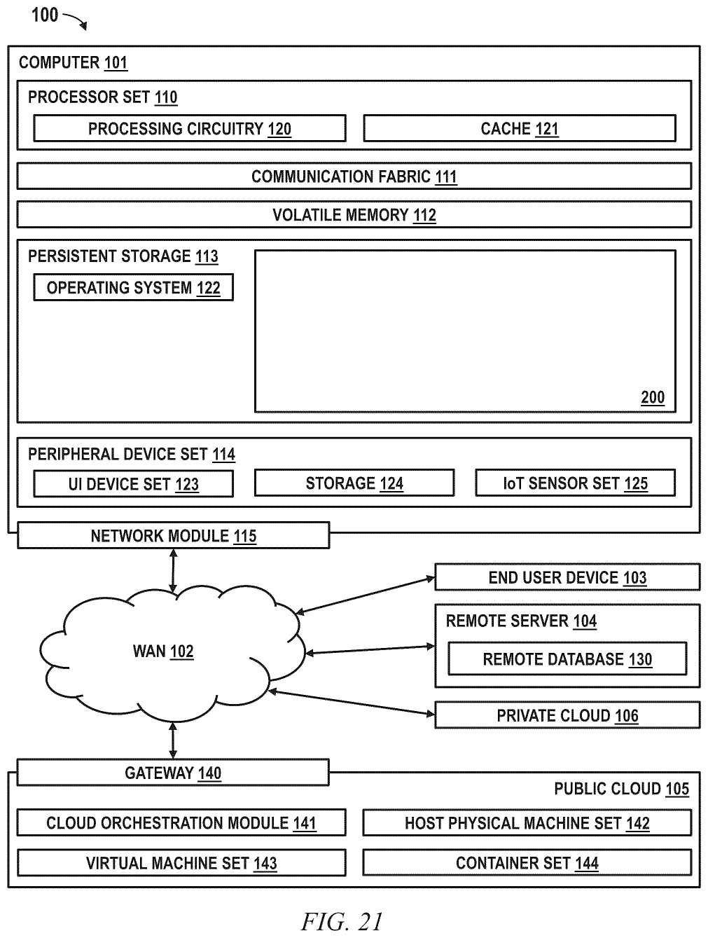

Refer now to FIG. 21.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

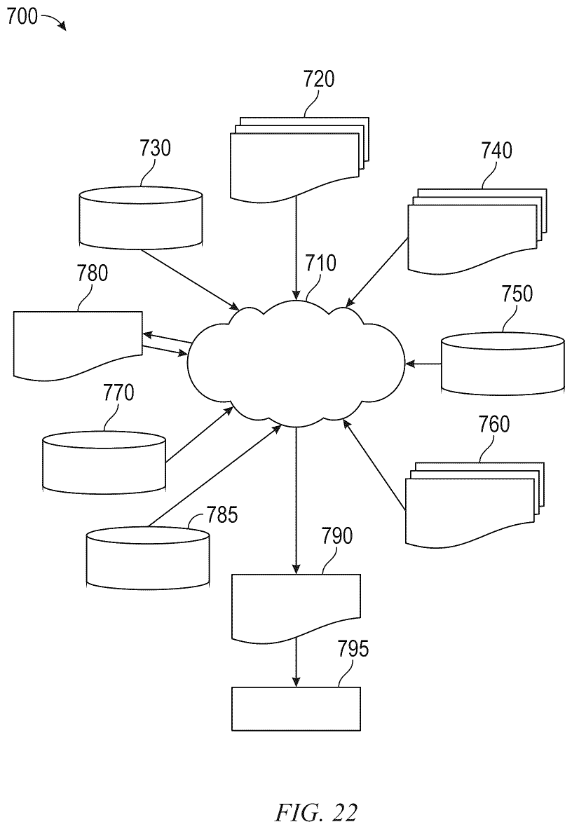

Computing environment 100 contains an example of an environment for the execution of at least some of the computer code involved in performing the inventive methods, such as a system (see block 200) for semiconductor design and/or control of semiconductor fabrication (see FIG. 22). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Exemplary Design Process Used in Semiconductor Design, Manufacture, and/or Test

One or more embodiments make use of computer-aided semiconductor integrated circuit design simulation, test, layout, and/or manufacture. In this regard, FIG. 22 shows a block diagram of an exemplary design flow 700 used for example, in semiconductor IC logic design, simulation, test, layout, and manufacture. Design flow 700 includes processes, machines and/or mechanisms for processing design structures or devices to generate logically or otherwise functionally equivalent representations of design structures and/or devices, such as those that can be analyzed using techniques disclosed herein or the like. The design structures processed and/or generated by design flow 700 may be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 700 may vary depending on the type of representation being designed. For example, a design flow 700 for building an application specific IC (ASIC) may differ from a design flow 700 for designing a standard component or from a design flow 700 for instantiating the design into a programmable array, for example a programmable gate array (PGA) or a field programmable gate array (FPGA) offered by Altera® Inc. or Xilinx® Inc.

FIG. 22 illustrates multiple such design structures including an input design structure 720 that is preferably processed by a design process 710. Design structure 720 may be a logical simulation design structure generated and processed by design process 710 to produce a logically equivalent functional representation of a hardware device. Design structure 720 may also or alternatively comprise data and/or program instructions that when processed by design process 710, generate a functional representation of the physical structure of a hardware device. Whether representing functional and/or structural design features, design structure 720 may be generated using electronic computer-aided design (ECAD) such as implemented by a core developer/designer. When encoded on a gate array or storage medium or the like, design structure 720 may be accessed and processed by one or more hardware and/or software modules within design process 710 to simulate or otherwise functionally represent an electronic component, circuit, electronic or logic module, apparatus, device, or system. As such, design structure 720 may comprise files or other data structures including human and/or machine-readable source code, compiled structures, and computer executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 710 preferably employs and incorporates hardware and/or software modules for synthesizing, translating, or otherwise processing a design/simulation functional equivalent of components, circuits, devices, or logic structures to generate a Netlist 780 which may contain design structures such as design structure 720. Netlist 780 may comprise, for example, compiled or otherwise processed data structures representing a list of wires, discrete components, logic gates, control circuits, I/O devices, models, etc. that describes the connections to other elements and circuits in an integrated circuit design. Netlist 780 may be synthesized using an iterative process in which netlist 780 is resynthesized one or more times depending on design specifications and parameters for the device. As with other design structure types described herein, netlist 780 may be recorded on a machine-readable data storage medium or programmed into a programmable gate array. The medium may be a nonvolatile storage medium such as a magnetic or optical disk drive, a programmable gate array, a compact flash, or other flash memory. Additionally, or in the alternative, the medium may be a system or cache memory, buffer space, or other suitable memory.

Design process 710 may include hardware and software modules for processing a variety of input data structure types including Netlist 780. Such data structure types may reside, for example, within library elements 730 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 740, characterization data 750, verification data 760, design rules 770, and test data files 785 which may include input test patterns, output test results, and other testing information. Design process 710 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 710 without deviating from the scope and spirit of the invention. Design process 710 may also include modules for performing standard circuit design processes such as timing analysis, verification, design rule checking, place and route operations, etc.

Design process 710 employs and incorporates logic and physical design tools such as HDL compilers and simulation model build tools to process design structure 720 together with some or all of the depicted supporting data structures along with any additional mechanical design or data (if applicable), to generate a second design structure 790. Design structure 790 resides on a storage medium or programmable gate array in a data format used for the exchange of data of mechanical devices and structures (e.g. information stored in an IGES, DXF, Parasolid XT, JT, DRG, or any other suitable format for storing or rendering such mechanical design structures). Similar to design structure 720, design structure 790 preferably comprises one or more files, data structures, or other computer-encoded data or instructions that reside on data storage media and that when processed by an ECAD system generate a logically or otherwise functionally equivalent form of one or more IC designs or the like. In one embodiment, design structure 790 may comprise a compiled, executable HDL simulation model that functionally simulates the devices to be analyzed.

Design structure 790 may also employ a data format used for the exchange of layout data of integrated circuits and/or symbolic data format (e.g. information stored in a GDSII (GDS2), GL1, OASIS, map files, or any other suitable format for storing such design data structures). Design structure 790 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described herein (e.g., .lib files). Design structure 790 may then proceed to a stage 795 where, for example, design structure 790: proceeds to tape-out, is released to manufacturing, is released to a mask house, is sent to another design house, is sent back to the customer, etc.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods may occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods may occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A matrix-vector multiplication device comprising:
an input encoder that encodes an input vector into a binary complement format value and a binary true format value;
a pulse generator that converts each encoded bit of the binary complement format value and each encoded bit of the binary true format value into a corresponding pulse signal;
a crossbar array of weights, wherein each weight is encoded as a differential analog conductance of at least two resistive memory devices, wherein the pulse generator simultaneously applies at least one pulse signal corresponding to a given encoded bit of the binary complement format value to a corresponding resistive memory device of the at least two resistive memory devices and at least one pulse signal corresponding to a given encoded bit of the binary true format value to a corresponding resistive memory device of the at least two resistive memory devices;
an analog-to-digital converter that digitizes outputs of the crossbar array of weights to generate partial dot-product results; and
a digital COMP counter that computes a final dot-product result from the partial dot-product results.

2. The matrix-vector multiplication device of claim 1, wherein each pulse signal produced by the pulse generator is applied as a voltage pulse to the crossbar array to compute a corresponding one of the partial dot-product results in an analog domain.

3. The matrix-vector multiplication device of claim 1, wherein each of the partial dot-product results are digitized individually by the analog-to-digital converter.

4. The matrix-vector multiplication device of claim 1, wherein outputs of the analog-to-digital converter are accumulated into the digital COMP counter via shift-and-add operations, whereby the outputs of the analog-to-digital converter corresponding to sign bits of the encoded input vector is scaled and subtracted from an accumulated value of the digital COMP counter.

5. The matrix-vector multiplication device of claim 1, wherein each weight encoded as the differential analog conductance is stored via four bitcells, the weights including a target conductance G_{P}, a conductance G_{M}−G_{P}, a conductance G_{N} and a conductance G_{M}−G_{N}.

6. The matrix-vector multiplication device of claim 1, wherein the digital COMP counter comprises a multiplication capability to apply a scaling factor α to a value stored in the digital COMP counter and an offset mismatch η is handled by the digital COMP counter by initializing the digital COMP counter with an initialization value defined by *η_{PN} (*η=η/α).

7. The matrix-vector multiplication device of claim 1, wherein the digital COMP counter is configured to:
perform a right-shift operation and a truncation of the least significant bit during one or more first-type cycles;
abstain from performing the right-shift operation for one second-type cycle; and
perform a left-shift operation for one cycle and the truncation of the least significant bit during a third-type cycle.

8. The matrix-vector multiplication device of claim 7, wherein the digital COMP counter is configured to subtract a final result of the shift operations from a counter value of the digital COMP counter after performance of the third-type cycle and wherein only a proper subset of bits of the digital COMP counter are configured to be transferred for further processing.

9. The matrix-vector multiplication device of claim 1, wherein the digital COMP counter is configured to add a value of a least significant bit from the partial dot-product results in a first cycle, configured to add a value of two least significant bits from the partial dot-product results in a second cycle, and is configured to add a value of three least significant bits from the partial dot-product results in a third cycle, and wherein a bit-resolution of an operation of the analog-to-digital converter is increased by 1-bit after each cycle to account for an IN-bit significance.

10. A matrix-vector multiplication device comprising:
an input encoder that encodes an input vector into a binary complement format value and a binary true format value;
a pulse generator that converts each of one or more sets of bits of the encoded binary complement format value and each of one or more sets of bits of the encoded binary true format value into a corresponding pulse signal;
a crossbar array of weights, wherein each weight is encoded as a differential analog conductance of at least two resistive memory devices, wherein the pulse generator simultaneously applies at least one pulse signal corresponding to a given set of the sets of bits of the encoded binary complement format value to a corresponding resistive memory device of the at least two resistive memory devices and at least one pulse signal corresponding to a given set of the sets of bits of the encoded binary true format value to a corresponding resistive memory device of the at least two resistive memory devices;
an analog-to-digital converter that digitizes outputs of the crossbar array of weights to generate partial dot-product results; and
a digital COMP counter that computes a final dot-product result from the partial dot-product results.

11. The matrix-vector multiplication device of claim 10, wherein a count of pulses generated by the pulse generator for the encoded binary complement format value and a count of pulses generated by the pulse generator for the encoded binary true format value is a same count value.

12. The matrix-vector multiplication device of claim 10, wherein each output of the analog-to-digital converter corresponding to one of the sets of bits is multiplied by a corresponding predetermined scaling factor and accumulated into the digital COMP counter.

13. The matrix-vector multiplication device of claim 10, wherein the pulse generator converts a sign bit of the encoded binary complement format value and a sign bit of the encoded binary true format value into corresponding sign pulse signals.

14. The matrix-vector multiplication device of claim 13, whereby the outputs of the analog-to-digital converter corresponding to the sign bit of the encoded binary complement format value and the sign bit of the encoded binary true format value are scaled and subtracted from an accumulated value of the digital COMP counter.

15. A hardware description language (HDL) design structure encoded on a machine-readable data storage medium, the HDL design structure comprising elements that when processed in a computer-aided design system generates a machine-executable representation of a semiconductor structure, wherein the HDL design structure comprises:
an input encoder that encodes an input vector into a binary complement format value and a binary true format value;
a pulse generator that converts each encoded bit of the binary complement format value and each encoded bit of the binary true format value into a corresponding pulse signal;
a crossbar array of weights, wherein each weight is encoded as a differential analog conductance of at least two resistive memory devices, wherein the pulse generator simultaneously applies at least one pulse signal corresponding to a given encoded bit of the binary complement format value to a corresponding resistive memory device of the at least two resistive memory devices and at least one pulse signal corresponding to a given encoded bit of the binary true format value to a corresponding resistive memory device of the at least two resistive memory devices;
an analog-to-digital converter that digitizes outputs of the crossbar array of weights to generate partial dot-product results; and
a digital COMP counter that computes a final dot-product result from the partial dot-product results.

16. The hardware description language (HDL) design structure of claim 15, wherein outputs of the analog-to-digital converter are accumulated into the digital COMP counter via shift-and-add operations, whereby the outputs of the analog-to-digital converter corresponding to sign bits of the encoded input vector is scaled and subtracted from an accumulated value of the digital COMP counter.

17. The hardware description language (HDL) design structure of claim 15, wherein each weight encoded as the differential analog conductance is stored via four bitcells, the weights including a target conductance G_{P}, a conductance G_{M}−G_{P}, a conductance G_{N} and a conductance G_{M}−G_{N}.

18. The hardware description language (HDL) design structure of claim 15, wherein the digital COMP counter comprises a multiplication capability to apply a scaling factor α to a value stored in the digital COMP counter and an offset mismatch f is handled by the digital COMP counter by initializing the digital COMP counter with an initialization value defined by *η_{PN} (*η=η/α).

19. The hardware description language (HDL) design structure of claim 15, wherein the digital COMP counter is configured to:
perform a right-shift operation and a truncation of the least significant bit during one or more first-type cycles;
abstain from performing the right-shift operation for one second-type cycle; and
perform a left-shift operation for one cycle and the truncation of the least significant bit during a third-type cycle.

20. The hardware description language (HDL) design structure of claim 19, wherein the digital COMP counter is configured to subtract a final result of the shift operations from a counter value of the digital COMP counter after performance of the third-type cycle and wherein only a proper subset of bits of the digital COMP counter are configured to be transferred for further processing.

21. The hardware description language (HDL) design structure of claim 15, wherein the digital COMP counter is configured to add a value of a least significant bit from the partial dot-product results in a first cycle, configured to add a value of two least significant bits from the partial dot-product results in a second cycle, and is configured to add a value of three least significant bits from the partial dot-product results in a third cycle, and wherein a bit-resolution of an operation of the analog-to-digital converter is increased by 1-bit after each cycle to account for an IN-bit significance.

22. A hardware description language (HDL) design structure encoded on a machine-readable data storage medium, the HDL design structure comprising elements that when processed in a computer-aided design system generates a machine-executable representation of a semiconductor structure, wherein the HDL design structure comprises:
an input encoder that encodes an input vector into a binary complement format value and a binary true format value;
a pulse generator that converts each of one or more sets of bits of the encoded binary complement format value and each of one or more sets of bits of the encoded binary true format value into a corresponding pulse signal;
a crossbar array of weights, wherein each weight is encoded as a differential analog conductance of at least two resistive memory devices, wherein the pulse generator simultaneously applies at least one pulse signal corresponding to a given set of the sets of bits of the encoded binary complement format value to a corresponding resistive memory device of the at least two resistive memory devices and at least one pulse signal corresponding to a given set of the sets of bits of the encoded binary true format value to a corresponding resistive memory device of the at least two resistive memory devices;
an analog-to-digital converter that digitizes outputs of the crossbar array of weights to generate partial dot-product results; and
a digital COMP counter that computes a final dot-product result from the partial dot-product results.

23. The hardware description language (HDL) design structure of claim 22, wherein each output of the analog-to-digital converter corresponding to one of the sets of bits is multiplied by a corresponding predetermined scaling factor and accumulated into the digital COMP counter.

24. The hardware description language (HDL) design structure of claim 22, wherein the pulse generator converts a sign bit of the encoded binary complement format value and a sign bit of the encoded binary true format value into corresponding sign pulse signals.

25. The hardware description language (HDL) design structure of claim 24, whereby the outputs of the analog-to-digital converter corresponding to the sign bit of the encoded binary complement format value and the sign bit of the encoded binary true format value are scaled and subtracted from an accumulated value of the digital COMP counter.
